(19) United States
(12) Patent Application Publication
(10) Pub. No.: US 2019/0076788 A1
(43) Pub. Date: Mar. 14, 2019

(54) PARTICLE CAPTURE FILTRATION FILM AND MANUFACTURING METHOD THEREOF, AND POROUS FILM AND MANUFACTURING METHOD THEREOF

(71) Applicant: ORGANO CORPORATION, Tokyo (JP)

(72) Inventors: Masami IMAMURA, Tokyo (JP); Hiroshi SUGAWARA, Tokyo (JP); Fumitaka ICHIHARA, Tokyo (JP)

(73) Assignee: ORGANO CORPORATION, Tokyo (JP)

(21) Appl. No.: 16/082,758

(22) PCT Filed: Mar. 3, 2017
(86) PCT No.: PCT/JP2017/008475

§ 371 Date: Sep. 6, 2018

(30) Foreign Application Priority Data
Mar. 11, 2016 (JP) 2016-047988

(51) Int. Cl. B01D 67/00; C02F 1/44; B01D 71/02; C25D 11/04; B01D 69/02

(52) U.S. Cl. CPC B01D 67/0065; C02F 1/44; B01D 69/02; C25D 11/04; B01D 71/025

(57) ABSTRACT

A particle capture filtration film with communication pores formed by anode oxidization of an aluminum material includes a small pore diameter part having communication pores formed to open to one surface of the filtration film, an intermediate pore part having communication pores to which the communication pores of the small pore diameter part are connected and that have a larger diameter than a diameter of the communication pores in the small pore diameter part, and a large pore diameter part having communication pores to which the communication pores of the intermediate pore part are connected and which have a larger diameter than a diameter of the communication pores in the intermediate pore part and are formed to open to the other surface of the filtration film.

### TECHNICAL FIELD

The present invention relates to particle capture filtration films in water to be treated, and particularly, to a particle capture filtration film used for measurement of the number of particles contained in ultrapure water and solvents for semiconductor manufacturing, or medical agents, and the like. In addition, the present invention relates to porous films having microscopic communication pores.

### BACKGROUND ART

At present, particles contained in ultrapure water and solvents used in a semiconductor manufacturing process, or medical agents, are managed to have a particle diameter of 50 to 100 nm. However, in recent years with high integration of semiconductor devices, a line width of the device has been miniaturized, and therefore there is a demand for the management of the particle diameter of approximately 10 nm as smaller particles.

An evaluation method for particles in the ultrapure water includes an online method utilizing laser scattering or the like and direct microscopy in which the ultrapure water is filtered by a particle capture film and the particles captured on the film are measured using an optical microscope or a scanning electron microscope. An anode oxide film is used as a particle capture film for direct microscopy. However, since the anode oxide film has a weak water resistance, the anode oxide film is required to be subjected to calcination treatment after anodizing (Patent Literature 1).

For example, FIG. 1 of Patent Literature 2 shows a film having a different-diameter structure, and an example thereof describes a minimum pore size of approximately 20 nm. As to commercially available anode oxidization films, films having a minimum pore diameter as small as 20 nm are commercially available.

### CITATION LIST

### Patent Literature

[Patent Literature 1]
Japanese Patent Application Laid-Open No. 2007-70126

[Patent Literature 2]
Japanese Patent Application Laid-Open No. 2-218422

### SUMMARY OF INVENTION

### Technical Problem

However, at present, there is no anode oxidization film having a pore diameter smaller than the above. Therefore development of an anode oxidization film having an average pore diameter of 20 nm or less has been recently desired to be capable of meeting the demand of the management of particles having a smaller pore diameter.

In the particle measurement using the anode oxidization film, the number of particles in the measurement object is measured by capturing particles with liquid passing of the measurement object, but the anode oxidization film is possibly damaged at the liquid passing of the measurement object liquid.

Accordingly the present invention has an object of providing a particle capture filtration film with communication pores formed by anodizing and having an average pore diameter smaller than conventional and being difficult to be damaged at the liquid passing of a measurement object, and a manufacturing method thereof. In addition, the present invention has an object of providing a porous film with communication pores formed by anodizing and having an average pore diameter smaller than conventional and being difficult to be damaged at the liquid passing, and a manufacturing method thereof.

### Solution to Problem

Such problems as described above are solved by the present invention as follows.

That is, the present invention (1) provides a particle capture filtration film with communication pores formed by anode oxidization of an aluminum material, including:

a small pore diameter part having communication pores formed to open to one surface of the filtration film;

an intermediate pore part having communication pores to which the communication pores of the small pore diameter part are connected and which have a larger diameter than a diameter of the communication pores in the small pore diameter part; and

a large pore diameter part having communication pores to which the communication pores of the intermediate pore part are connected and which have a larger diameter than a diameter of the communication pores in the intermediate pore part and are formed to open to the other surface of the filtration film, wherein

the small pore diameter part is provided with the communication pores formed from the one surface of the filtration film to a position of at least 400 nm, the communication pores having an average pore diameter of 4 to 20 nm,

a total film thickness of the filtration film is equal to or less than 50 μm, and

the communication pores of the large pore diameter part have a large pore diameter part narrow portion in the intermediate pore part side.

The present invention (2) provides a manufacturing method of a particle capture filtration film, including:

a first anode oxidization process (A) of anodizing an aluminum material to form a progenitor communication pore of a communication pore for a large pore diameter part on the aluminum material and obtain an anode oxidization aluminum material (1A);

pore diameter enlarging treatment of immersing the anode oxidization aluminum material (1A) in any aqueous solution of an oxalic acid aqueous solution, a chromic acid aqueous solution, a phosphoric acid aqueous solution, a sulfuric acid aqueous solution, a mixed acid aqueous solution of them or an alkaline aqueous solution to enlarge a diameter of the progenitor communication pore and form the communication pore for the large pore-diameter part;

a second anode oxidization process (A) of anodizing the anode oxidization aluminum material (1A) subjected to pore diameter enlarging treatment to form a large pore diameter part narrow portion smaller in diameter than the communication pore for the large pore diameter part on an end of the communication pore for the large pore diameter part in the anode oxidization aluminum material (1A) subjected to the pore diameter enlarging treatment and obtain an anode oxidization aluminum material (2);

a third anode oxidization process of anodizing the anode oxidization aluminum material (2) to form a communication pore for the intermediate pore part that is connected to the large pore diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);

a fourth anode oxidization process of anodizing the anode oxidization aluminum material (3) to form a communication pore for a small pore diameter part that is connected to the communication pore for the intermediate pore part and is smaller in diameter than the communication pore for the intermediate pore part and obtain an anode oxidization aluminum material (4);

a separation and etching process of separating an anodized section from the anode oxidization aluminum material (4) and next, executing etching treatment to the separated section to obtain an anodized section; and

a calcination process of firing the anodized portion at a temperature of 800 to 1200° C. to obtain a particle capture filtration film, wherein

in the fourth anode oxidization process, the communication pores having an average pore diameter of 4 to 20 nm are formed in a range of 400 nm or more in a thickness direction, and

from the first anode oxidization process to the fourth anode oxidization process, a total thickness of sections on which the communication pores are formed by the anode oxidization is equal to or less than 50 μm.

The present invention (3) provides a manufacturing method of a particle capture filtration film, including:

a first anode oxidization process (B) of anodizing an aluminum material to form a communication pore for a large pore diameter part on the aluminum material and obtain an anode oxidization aluminum material (1B);

a second anode oxidization process (B) of anodizing the anode oxidization aluminum material (1B) to form a large pore diameter part narrow portion smaller in diameter than the communication pore for the large pore diameter part on an end of the communication pore for the large pore diameter part in the anode oxidization aluminum material (1B) and obtain an anode oxidization aluminum material (2);

a third anode oxidization process of anodizing the anode oxidization aluminum material (2) to form a communication pore for an intermediate pore part that is connected to the large pore diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);

a fourth anode oxidization process of anodizing the anode oxidization aluminum material (3) to form a communication pore for a small pore-diameter part that is connected to the communication pore for the intermediate pore part and is smaller in diameter than the communication pore for the intermediate pore part and obtain an anode oxidization aluminum material (4);

a separation and etching process of separating an anodized section from the anode oxidization aluminum material (4) and next, executing etching treatment to the separated section to obtain an anodized section; and

a calcination process of firing the anodized section at a temperature of 800 to 1200° C. to obtain a particle capture filtration film, wherein

in the fourth anode oxidization process, the communication pores having an average pore diameter of 4 to 20 nm are formed in a range of 400 nm or more in a thickness direction, and

from the first anode oxidization process to the fourth anode oxidization process, a total thickness of sections on which the communication pores are formed by the anode oxidization is equal to or less than 50 μm.

The present invention (4) provides a porous film with communication pores formed by anode oxidization of an aluminum material, including:

a small pore diameter part having communication pores formed to open to one surface of the porous film;

an intermediate pore part having communication pores to which the communication pores of the small pore diameter part are connected and which is larger in diameter than the communication pores in the small pore diameter part; and

a large pore diameter part having communication pores to which communication pores of an intermediate pore part are connected and which are larger in diameter than the communication pores in the intermediate pore part and are formed to open to the other surface of the porous film, wherein

the small pore diameter part is provided with the communication pores formed from the one surface of the porous film to a position of at least 400 nm, the communication pores having an average pore diameter of 4 to 20 nm,

a total film thickness of the porous film is equal to or less than 50 μm, and

the communication pores of the large pore diameter part have a large pore diameter part narrow portion in the intermediate pore part side.

The present invention (5) provides a manufacturing method of a porous film, including:

a first anode oxidization process (A) of anodizing an aluminum material to form a progenitor communication pore of a communication pore for a large pore diameter part on the aluminum material and obtain an anode oxidization aluminum material (1A);

pore diameter enlarging treatment of immersing the anode oxidization aluminum material (1A) in any aqueous solution of an oxalic acid aqueous solution, a chromic acid aqueous solution, a phosphoric acid aqueous solution, a sulfuric acid aqueous solution, a mixed acid aqueous solution of them or an alkaline aqueous solution to enlarge a diameter of the progenitor communication pore and form the communication pores for the large pore diameter part;

a second anode oxidization process (A) of anodizing the anode oxidization aluminum material (1A) subjected to pore diameter enlarging treatment to form a large pore diameter part narrow portion smaller in diameter than the communication pore for the large pore diameter part on an end of the communication pore for the large pore diameter part in the anode oxidization aluminum material (1A) subjected to the pore-diameter enlarging treatment and obtain an anode oxidization aluminum material (2);

a third anode oxidization process of anodizing the anode oxidization aluminum material (2) to form a communication pore for an intermediate pore part that is connected to the large pore-diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);

a fourth anode oxidization process of anodizing the anode oxidization aluminum material (3) to form a communication pore for a small pore diameter part that is connected to the communication pore for the intermediate pore part and is smaller in diameter than the communication pore for the intermediate pore part and obtain an anode oxidization aluminum material (4);

a separation and etching process of separating an anodized section from the anode oxidization aluminum material (4) and next, executing etching treatment to the separated section to obtain an anodized section; and

a calcination process of firing the anodized section at a temperature of 800 to 1200° C. to obtain a particle capture filtration film, wherein

in the fourth anode oxidization process, the communication pores having an average pore diameter of 4 to 20 nm are formed in a range of 400 nm or more in a thickness direction, and

from the first anode oxidization process to the fourth anode oxidization process, a total thickness of sections on which the communication pores are formed by the anode oxidization is equal to or less than 50 μm.

The present invention (6) provides a manufacturing method of a porous film, including:

a first anode oxidization process (B) of anodizing an aluminum material to form a communication pore for a large pore diameter part on the aluminum material and obtain an anode oxidization aluminum material (1B);

a second anode oxidization process (B) of anodizing the anode oxidization aluminum material (1B) to form a large pore diameter part narrow portion smaller in diameter than the communication pore for the large pore-diameter part on an end of the communication pore for the large pore diameter part in the anode oxidization aluminum material (1B) and obtain an anode oxidization aluminum material (2);

a third anode oxidization process of anodizing the anode oxidization aluminum material (2) to form a communication pore for an intermediate pore part that is connected to the large pore diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);

a fourth anode oxidization process of anodizing the anode oxidization aluminum material (3) to form a communication pore for a small pore diameter part that is connected to the communication pore for the intermediate pore part and is smaller in diameter than the communication pore for the intermediate pore part and obtain an anode oxidization aluminum material (4);

a separation and etching process of separating an anodized section from the anode oxidization aluminum material (4) and next, executing etching treatment to the separated section to obtain an anodized section; and

a calcination process of firing the anodized section at a temperature of 800 to 1200° C. to obtain a particle capture filtration film, wherein

in the fourth anode oxidization process, the communication pores having an average pore diameter of 4 to 20 nm are formed in a range of 400 nm or more in a thickness direction, and

from the first anode oxidization process to the fourth anode oxidization process, a total thickness of sections on which the communication pores are formed by the anode oxidization is equal to or less than 50 μm.

### Advantageous Effect of Invention

The present invention can provide the particle capture filtration film with the communication pores formed by the anode oxidization and having the average pore diameter smaller than conventional and being difficult to be damaged at the liquid passing of the measurement object, and the manufacturing method thereof. In addition, the present invention has an object of providing the porous film with the communication pores formed by anode oxidization and having the average pore diameter smaller than conventional and being difficult to be damaged at the liquid passing, and the manufacturing method thereof.

### BRIEF DESCRIPTION OF DRAWINGS

FIG. 1 is an enlarged diagram of a section surrounded in a dotted line indicated at a sign 40 in FIG. 2.

FIG. 2 is a schematic end elevational view of an example of a particle capture filtration film of the present invention.

FIG. 3 is an enlarged diagram of a section surrounded in a dotted line indicated at a sign 39 in FIG. 2.

FIG. 4 is a concept diagram showing an anode oxidization process.

FIG. 5A is a schematic end elevational view showing a state where an aluminum material is anodized.

FIG. 5B is a schematic end elevational view showing a state where an aluminum material is anodized.

FIG. 5C is a schematic end elevational view showing a state where an aluminum material is anodized.

FIG. 5D is a schematic end elevational view showing a state where an aluminum material is anodized.

FIG. 5E is a schematic end elevational view showing a state where an aluminum material is anodized.

FIG. 5F is a schematic end elevational view showing a state where an aluminum material is anodized.

FIG. 6 is a schematic end elevational view in the vicinity of one surface in an example of a particle capture filtration film of the present invention.

FIG. 7 is a schematic view of one surface in an example of a particle capture filtration film of the present invention.

FIG. 8 is a schematic end elevational view in the vicinity of one surface in an example of a particle capture filtration film of the present invention.

FIG. 9 is a schematic end elevational view in the vicinity of one surface in an example of a particle capture filtration film of the present invention.

FIG. 10 is an SEM image (magnification ratio of 5000 times) of a cross-sectional surface of a particle capture filtration film of Example 1.

FIG. 11 is an SEM image (magnification ratio of 10000 times) of a surface in a small pore diameter side of a particle capture filtration film of Example 1.

FIG. 12 is an SEM image (magnification ratio of 25000 times) of a surface in a small pore diameter side of a particle capture filtration film of Example 1.

FIG. 13 is an SEM image (magnification ratio of 30000 times) of a cross-sectional surface of a particle capture filtration film of Comparative Example 1.

FIG. 14 is an SEM image (magnification ratio of 10000 times) of a surface in a small pore diameter side of a particle capture filtration film of Comparative Example 1.

FIG. 15 is an SEM image (magnification ratio of 50000 times) of a surface in a small pore diameter side of a particle capture filtration film of Comparative Example 1.

FIG. 16 is an SEM image (magnification ratio of 25000 times) of a surface in a small pore diameter side of a particle capture filtration film of Comparative Example 2.

### DESCRIPTION OF EMBODIMENTS

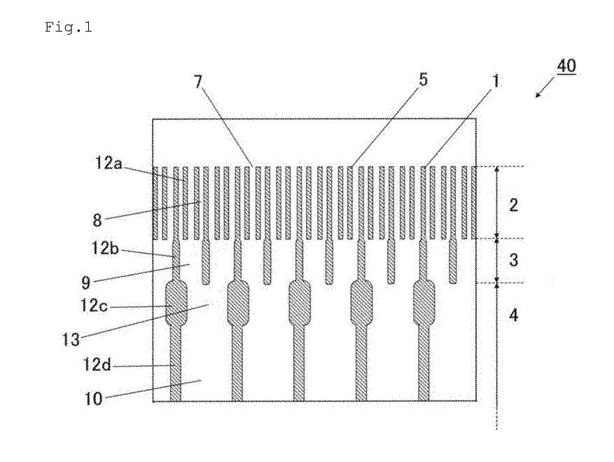

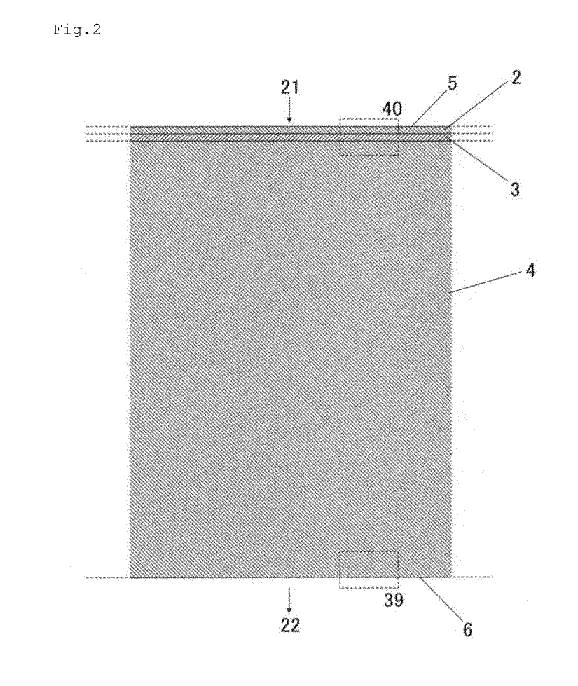

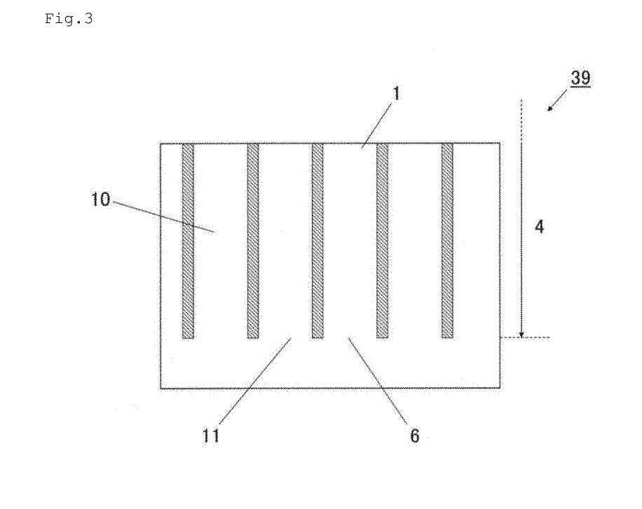

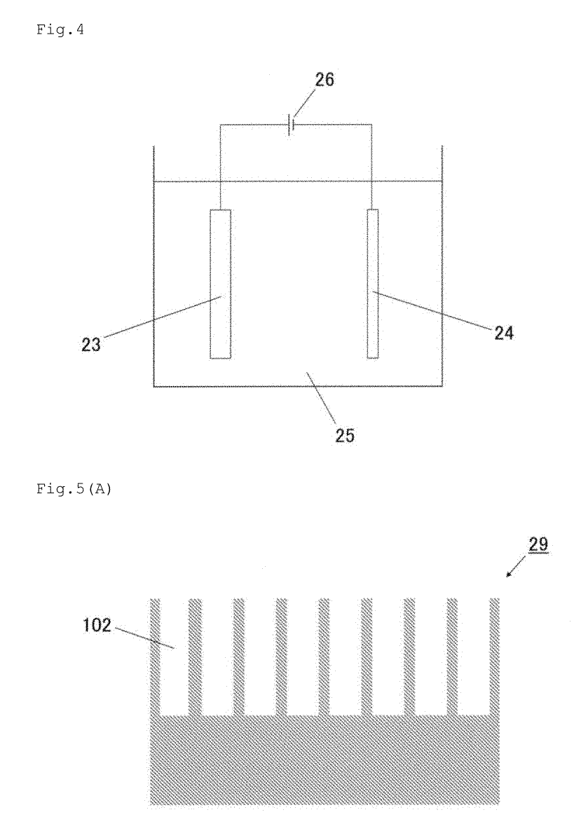

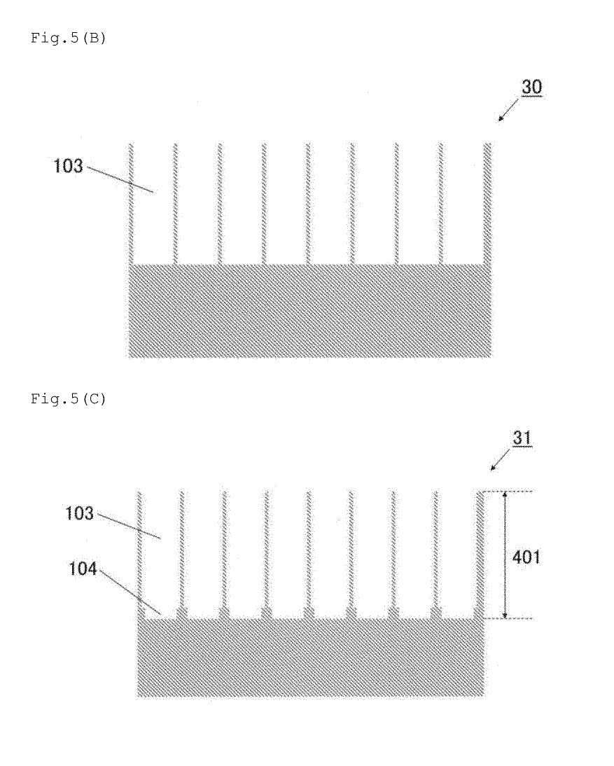

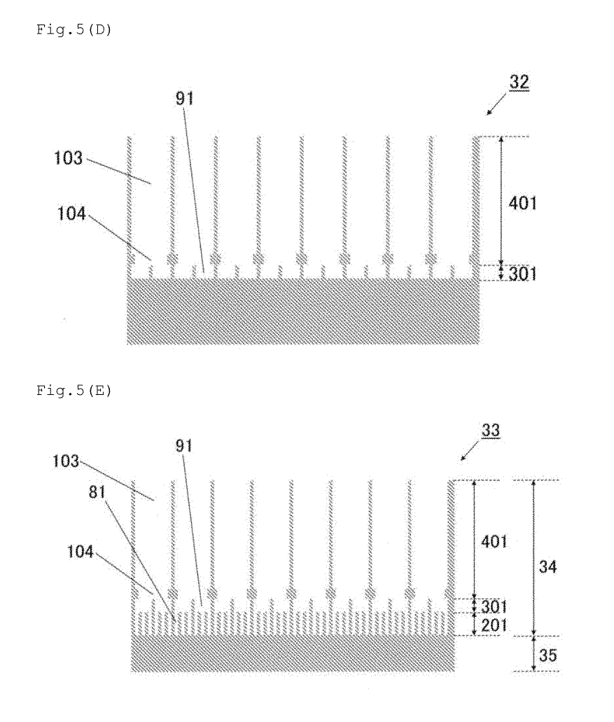

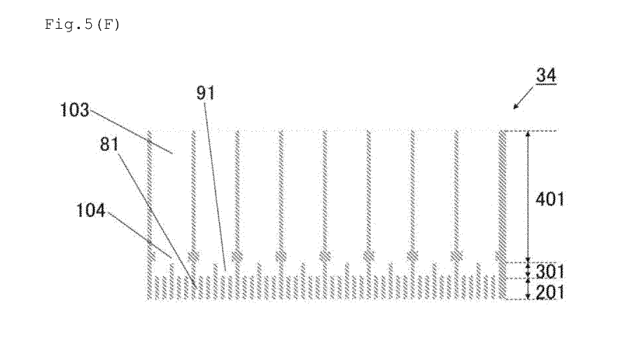

An explanation will be made of a particle capture filtration film and a manufacturing method thereof of the present invention with reference to FIG. 1 to FIG. 5. FIG. 1 is an enlarged diagram of a section surrounded in a dotted line indicated at a sign 40 in FIG. 2, and is an enlarged diagram in the vicinity of one surface of a filtration film. FIG. 2 is a schematic view of an example of a particle capture filtration film of the present invention, and is an end elevational diagram at the time of vertically cutting the surface of the filtration film. FIG. 3 is an enlarged diagram of a section surrounded in a dotted line indicated at a sign 39 in FIG. 2, and is an enlarged diagram in the vicinity of the other surface of a filtration film. FIG. 4 is a concept diagram showing an anode oxidization process. FIG. 5 is a schematic diagram showing a state where an aluminum material is anodized, and is an end elevational diagram at the time of vertically cutting the surface of the filtration film.

As shown in FIG. 1 to FIG. 3, a particle capture filtration film 1 includes a small pore diameter part 2 in which communication pores having an average pore diameter of 4 to 20 nm are formed, an intermediate pore part 3 in which communication pores larger in diameter than the communication pores of the small pore diameter part are formed and a large pore diameter part 4 in which communication pores larger in diameter than the communication pores of the intermediate pore part are formed. The communication pores of the large pore diameter part 4 have a large pore diameter part narrow portion 13 in the intermediate pore part 3 side. The large pore diameter part narrow portion 13 is a section smaller in pore diameter than communication pores in a section near the large pore diameter part narrow portion 13 and closer to the opening side than the large pore diameter part narrow portion 13 among the communication pores of the large pore diameter part. The communication pores of the intermediate pore part 3 are connected to the communication pores of the large pore diameter part 4, but are specifically connected to the large pore diameter part narrow portion 13 of the communication pores in the large pore diameter part 4. A total thickness of the small pore diameter part 2, the intermediate pore part 3 and the large pore diameter part 4, that is, a total film thickness of the particle capture filtration film 1 is equal to or less than 50 μm. It should be noted that the communication pores are, as shown in FIG. 1 and FIG. 3, formed in the small pore diameter part 2, the intermediate pore part 3 and the large pore diameter part 4 of the particle capture filtration film 1, but in FIG. 2, for the drawing purposes, only existing positions in the small pore diameter part 2, the intermediate pore part 3 and the large pore diameter part 4 are shown in a hatched line. A section shown in a hatched line in FIG. 2 is a part of the small pore diameter part 2, the intermediate pore part 3 and the large pore diameter part 4 of the particle capture filtration film 1, and actually the small pore diameter part 2, the intermediate pore part 3 and the large pore diameter part 4 are continuous in both of the left and right directions of the hatched section in FIG. 2.

The small pore diameter part 2 is formed on one surface 5 side of the particle capture filtration film 1 and an opening 7 of a communication pore 8 in the small pore diameter part 2 opens on the one surface 5 of the filtration film. The large pore diameter part 4 is formed on the other surface 6 side of the particle capture filtration film 1 and an opening 11 of a communication pore 10 in the large pore diameter part 4 opens on the one surface 6 of the filtration film. The communication pore 10 of the large pore diameter part 4 has the large pore diameter part narrow portion 13 in the intermediate pore part. That is, the large pore diameter part 4 is provided with the large pore diameter part narrow portion 13 formed in the intermediate pore part 3 side. The intermediate pore part 3 is formed between the small pore diameter part 2 and the large pore diameter part 4, and the communication pore 8 in the small pore diameter part 2 is connected to the communication pore 9 in the intermediate pore part 3, and the communication pore 9 in the intermediate pore part 3 is connected to the large pore diameter part narrow portion 13 formed in the intermediate pore part 3 side in the communication pore 10 of the large pore diameter part 4. Therefore the communication pore 8 in the small pore diameter part 2, the communication pore 9 in the intermediate pore part 3 and the communication pore 10 of the large pore diameter part 4 form communication pores continuous from the one surface 5 to the other surface 6 in the particle capture filtration film 1.

The communication pores 8 in the small pore diameter part 2 are continuous to the communication pore 9 in the intermediate pore part 3, and the communication pores 9 in the intermediate pore part 3 are continuous to the communication pore 10 of the large pore diameter part 4.

A skeletal part of the particle capture filtration film 1 can be obtained by anodizing an aluminum material, next separating the anodized section from the aluminum material, next executing etching treatment to a surface of the anodized section and firing the anodized section, and therefore is formed of the oxidized aluminum. That is, the communication pores 8 in the small pore diameter part 2, the communication pore 9 in the intermediate pore part 3, and the communication pore 10 of the large pore diameter part 4 are formed of walls 12a, 12b, 12c, 12d of the oxidized aluminum.

Water 21 to be treated such as ultrapure water is supplied in the filtration film from the one surface 5 side of the particle capture filtration film 1, transmits through the communication pores in the filtration film, and is discharged as treatment water 22 out of the filtration film from the other surface 6 side of the particle capture filtration film 1. At this time, particles in the water 21 to be treated such as ultrapure water are captured on the one surface 5 side of the particle capture filtration film 1.

Such communication pores of the particle capture filtration film 1 are formed by anode oxidization as shown in FIG. 4. The anode oxidization is performed by immersing an aluminum material 23 and a paired pole material 24 composed of a material such as aluminum, copper, nickel and platinum in an electrolytic solution 25 and applying a DC power source 26 in such a manner that a DC current flows from the aluminum material 23 to the paired pole material 24.

The anode oxidization in the manufacture of the particle capture filtration film 1 is executed separately in four processes of executing, after executing anode oxidization (FIG. 5 (A)) and pore diameter enlarging treatment (FIG. 5 (B)) for forming progenitor communication pores 102 of the communication pores for the large pore diameter part to the aluminum material 23, anode oxidization (FIG. 5 (C)) for forming the large pore diameter part narrow portion, anode oxidization (FIG. 5 (D)) for forming communication pores 91 for the intermediate pore part and anode oxidization (FIG. 5 (E)) for forming communication pores 81 for the small pore diameter part. The communication pore 103 for the large pore diameter part, the large pore diameter part narrow portion 104, the communication pore 91 for the intermediate pore part and the communication pore 81 for the small pore diameter part are communication pores composed of the communication pore 10 of the large pore diameter part 4, the large pore diameter part narrow portion 13, the communication pore 9 of the intermediate pore part 3 and the communication pore 8 of the small pore diameter part 2 in the particle capture filtration film 1 through to the calcination.

First, in the anode oxidization for forming the progenitor communication pores 102 of the communication pores for the large pore diameter part as shown in FIG. 5 (A), the progenitor communication pores 102 of the communication pores for the large pore diameter part are formed from the surface of the aluminum material 23 by the anode oxidization to obtain the anode oxidization aluminum material (1A) 29. Next, as shown in FIG. 5 (B), the aluminum material in which the progenitor communication pores 102 are formed is immersed in any aqueous solution of an oxalic acid aqueous solution, a chromic acid aqueous solution, a phosphoric acid aqueous solution, a sulfuric acid aqueous solution, a mixed acid aqueous solution of them or an alkaline aqueous solution to enlarge a diameter of the progenitor communication pore 102 and form the communication pores 103 for the large pore diameter. Next, in the anode oxidization for forming the large pore diameter part narrow portion 104 as shown in FIG. 5 (C), the large pore diameter part narrow portion 104 is formed on an end of the communication pore 103 for the large pore diameter formed in the anode oxidization aluminum material (1A) 30 subjected to the pore diameter enlarging treatment by the anode oxidization to obtain an anode oxidization aluminum material (2) 31. Next, in the anode oxidization for forming the communication pores 91 for the intermediate pore part as shown in FIG. 5 (D), the communication pores 91 for the intermediate pore part are formed on an end of the large pore diameter part narrow portion 104 formed in the anode oxidization aluminum material (2) 31 by the anode oxidization to obtain an anode oxidization aluminum material (3) 32. Next, in the anode oxidization for forming the communication pores 81 for the small pore diameter part as shown in FIG. 5 (E), the communication pores 81 for the small pore diameter part are formed on an end of the communication pores 91 formed in the anode oxidization aluminum material (3) 32 by the anode oxidization to obtain an anode oxidization aluminum material (4) 33. It should be noted that production of the progenitor communication pore 102, the large pore diameter part narrow portion 104, the communication pore 91 and the communication pore 81 is made by optionally selecting conditions of the anode oxidization such as a voltage to be applied, current to be supplied, a time to be applied and a kind of the electrolytic solution, which will be described later. In addition, a section indicated at a sign 401, a section indicated at a sign 301, a section indicated at a sign 201 as shown in FIG. 5 are respectively sections of becoming the large pore diameter part 4, the intermediate pore part 3 and the small pore diameter part 2 in the particle capture filtration film 1, and respectively a section corresponding to the large pore diameter part 4, a section corresponding to the intermediate pore part 3 and a section corresponding to the small pore diameter part 2 in the particle capture filtration film 1.

An anodized section 34 is separated from an aluminum material section 35 of the anode oxidization aluminum material (4) 33 obtained after performing the anode oxidization of the four processes as described above, and next, etching treatment is executed to the surface of the obtained anodized section 34 to the anodized section 34 as shown in FIG. 5 (F).

Next, the anodized section 34 obtained by the etching treatment is fired at 800 to 1200° C. to obtain the particle capture filtration film 1.

In this way, the particle capture filtration film 1 is a particle capture filtration film obtained by forming the communication pores by the anode oxidization of the aluminum material.

A particle capture filtration film of the present invention is a particle capture filtration film obtained by forming communication pores by anode oxidization of an aluminum material, including:

a small pore diameter part having communication pores formed to open to one surface of the filtration film;

an intermediate pore part having communication pores to which communication pores of a small pore diameter part are connected and which have a larger diameter than a diameter of the communication pores in the small pore diameter part; and

a large pore diameter part having communication pores to which communication pores of an intermediate pore part are connected and which have a larger diameter than a diameter of the communication pores in the intermediate pore part and are formed to open to the other surface of the filtration film, wherein

the small pore diameter part is provided with the communication pores formed from the one surface of the filtration film to a position of at least 400 nm, the communication pores having an average pore diameter of 4 to 20 nm,

a total film thickness of the filtration film is equal to or less than 50 μm, and

the communication pores of the large pore diameter part have a large pore diameter part narrow portion in the intermediate pore part-side.

The aluminum material according to the particle capture filtration film of the present invention is a raw material for manufacturing the particle capture filtration film of the present invention, and is a material to be anodized. The particle capture filtration film of the present invention is a material composed primarily of aluminum, and particularly not limited, when many impurities are contained in the aluminum, defects tend to be easily created at manufacturing. Therefore a degree of purity of the aluminum material is preferably equal to or more than 98.5 mass %, particularly preferably equal to or more than 99.0 mass %.

The particle capture filtration film of the present invention is a particle capture filtration film obtained by forming the communication pores by the anode oxidization of the aluminum material, and in more detail, by forming the communication pores by anodizing the aluminum material, next separating the anodized section from the aluminum material, next executing surface etching treatment to the anodized section, and next firing the anodized section. In the particle capture filtration film of the present invention, the communication pores of the small pore diameter part, the communication pores of the intermediate pore part, the large pore diameter part narrow portion and the communication pores of the large pore diameter part can be obtained in such a manner that first, conditions of the anode oxidization such as a voltage to be applied, current to be supplied, a time to be applied, and a kind of an electrolytic solution are selected, the communication pores of the large pore diameter part, the large pore diameter part narrow portion, the communication pores of the intermediate pore part and the communication pores of the small pore diameter part are formed in the aluminum material by the anode oxidization, and next, the separation of the anodized section, and the etching treatment and firing of the anodized section are performed.

The particle capture filtration film of the present invention includes a small pore diameter part in which communication pores having an average pore diameter of 4 to 20 nm are formed, an intermediate pore part to which the communication pores of the small pore diameter part are connected and in which communication pores larger in diameter than the communication pores of the small pore diameter part are formed and a large pore diameter part to which the communication pores of the intermediate pore part are connected and in which communication pores larger in diameter than the communication pores of the intermediate pore part are formed. The communication pores of the large pore diameter part have a large pore diameter part narrow portion in the intermediate pore part side. The large pore diameter part narrow portion is a section smaller in pore diameter than a communication pore in a section near the large pore diameter part narrow portion and closer to the opening side than the large pore diameter part narrow portion among the communication pores of the large pore diameter part. The communication pores of the intermediate pore part are connected to the large pore diameter part narrow portion among the communication pores of the large pore diameter part. The communication pores of the small pore diameter part, the communication pores of the intermediate pore part, the large pore diameter part narrow portion and the communication pores of the large pore diameter part extend in a direction vertically to one surface and the other surface of the particle capture filtration film, that is, in the thickness direction of the filtration film.

The small pore diameter part is formed on one surface side of the particle capture filtration film of the present invention and the communication pores in the small pore diameter part open on the one surface of the particle capture filtration film of the present invention. The large pore diameter part is formed on the other surface side of the particle capture filtration film of the present invention and the communication pores in the large pore diameter part open on the other surface of the particle capture filtration film of the present invention. The communication pores of the large pore diameter part have the large pore diameter part narrow portion in the intermediate pore part side. The intermediate pore part is formed between the small pore diameter part and the large pore diameter part, and the communication pores in the small pore diameter part are connected to the communication pores in the intermediate pore part, and the communication pores in the intermediate pore part are connected to the large pore diameter part narrow portion in the communication pores of the large pore diameter part. Therefore there are formed the communication pores for the passing of the water to be treated in order of the communication pores in the small pore diameter part, the communication pores in the intermediate pore part, the large pore diameter part narrow portion and the communication pores of the large pore diameter part from the one surface to the other surface in the particle capture filtration film of the present invention.

Only one communication pore in the small pore diameter part may be connected to the communication pore in the intermediate pore part, and the communication pores in the small pore diameter part may be connected to the communication pore in the intermediate pore part. Only one communication pore in the intermediate pore part may be connected to the large pore diameter part narrow portion of the communication pore of the large pore diameter part. In addition, since the particle capture filtration film of the present invention has the structure that a plurality of communication pores of the small pore diameter part are connected to the communication pore of the intermediate pore part, and a plurality of communication pores of intermediate pore part are connected to the large pore diameter part narrow portion of the communication pore in the large pore diameter part, in other words, the structure that a plurality of the communication pores in the intermediate pore part extend from an end (in detail, the large pore diameter part narrow portion) of one communication pore of the large pore diameter part, and a plurality of the communication pores in the small pore diameter part extend from an end of one communication pore of the intermediate pore part, the communication pores of the small pore diameter part can be densely disposed on the one surface of the particle capture filtration film, causing the water to be treated to easily flow.

The small pore diameter part according to the particle capture filtration film of the present invention is provided with the communication pores formed from one surface of the filtration film to a position of at least 400 nm, the communication pores having an average pore diameter of 4 to 20 nm, preferably 8 to 20 nm, particularly preferably 9 to 15 nm, more preferably 9 to 12 nm. That is, in the small pore diameter part, the pores of the average pore diameter of 4 to 20 nm, preferably 8 to 20 nm, particularly preferably 9 to 15 nm, or more preferably 9 to 12 nm are continuous from at least one surface of the filtration film to a position of at least 400 nm. In other words, a thickness of the small pore diameter part in which the pores of the average pore diameter of 4 to 20 nm, preferably 8 to 20 nm, particularly preferably 9 to 15 nm, or more preferably 9 to 12 nm are continuous is equal to or more than 400 nm. Since the average pore diameter of the communication pores of the small pore diameter part is in the above range, excellent performance can be accomplished as the particle capture filtration film to be used in direct microscopy. When the thickness of the small pore diameter part is equal to or more than 400 nm, the damage of the communication pores of the small pore diameter part in the anodized section obtained by the anode oxidization, the separation and the etching is made a little. In the small pore diameter part, the structure that the communication pores of the average pore diameter of 4 to 20 nm, preferably 8 to 20 nm, particularly preferably 9 to 15 nm, or more preferably 9 to 12 nm are not formed beyond a position of at least 1000 nm from one surface of the filtration film, that is, the structure that the thickness of the small pore diameter part is equal to or less than 1000 nm is preferable from a point of view that a transmission flow amount due to pressure loss is not too low at the liquid passing of the water to be treated. The thickness of the small pore diameter part is preferably 400 to 1000 nm, particularly 400 to 700 nm.

The average pore diameter of the communication pores of the whole small pore diameter part is 4 to 20 nm, preferably 8 to 20 nm, particularly preferably 9 to 15 nm, more preferably 9 to 12 nm. When the average pore diameter of the communication pores of the whole small pore diameter part is in the above range, excellent performance can be accomplished as the particle capture filtration film to be used in direct microscopy.

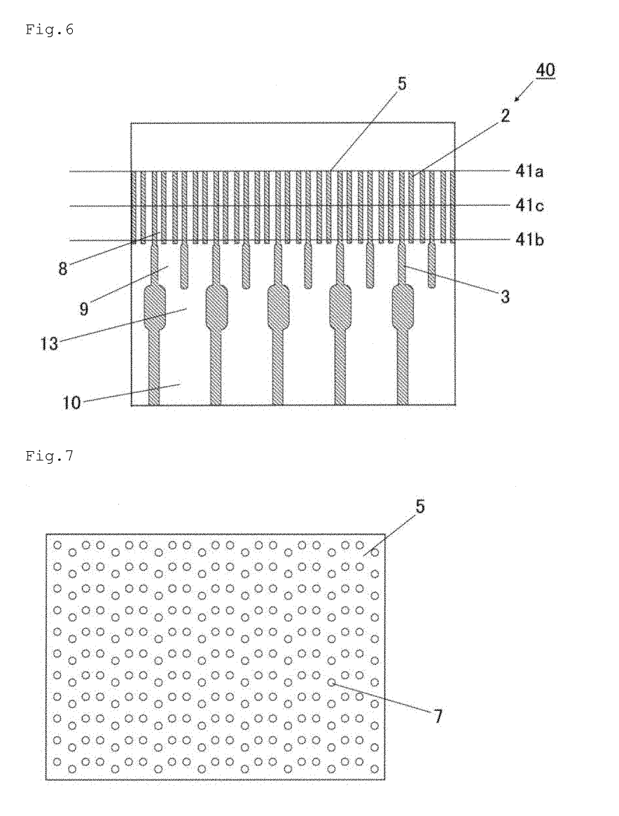

In the present invention, for example, the confirmation that the communication pores having the average pore diameter of 4 to 20 nm are formed from one surface of the filtration film to a position of at least 400 nm is made based upon an SEM image obtained by observing a cross-sectional surface by cutting the particle capture filtration film in the thickness direction using a scanning electron microscope. A specific confirmation method will be explained with reference to FIG. 6. In the present invention, the average pore diameter of the communication pores of the whole small pore diameter part will be found as follows. FIG. 6 is a schematic SEM image 40 of a cross-sectional surface in the vicinity of the surface of a particle capture filtration film. First, a straight line 41a is drawn in parallel with one surface of the filtration film in a position of the surface of the filtration film in a section of the small pore diameter part 2 on the SEM image 40. Next, sections of the straight line 41a overlapping the respective communication pores 8 are each measured, and the respective lengths are averaged to calculate an average value, thus finding an average pore diameter of the communication pores in a position of the surface of the filtration film in the small pore diameter part 2. Next, a straight line 41b is drawn in parallel with one surface of the filtration film in the vicinity of a position of sections of the small pore diameter part 2 connected to the communication pores 9 of the intermediate pore part 3, next, lengths of sections of the straight line 41b overlapping the respective communication pores 8 are each measured, and the respective lengths are averaged to calculate an average value, thus finding an average pore diameter of the communication pores in the position vicinity connected to the communication pores 9 of the intermediate pore part 3. Next, a straight line 41c is drawn in parallel with one surface of the filtration film in the vicinity of a position of an intermediate position between the surface of the filtration film and the vicinity of a position connected to the communication pores 9 of the intermediate pore part 3, next, lengths of sections of the straight line 41c overlapping the respective communication pores 8 are each measured, and the respective lengths are averaged to calculate an average value, thus finding an average pore diameter of the communication pores in the vicinity of the intermediate position between the surface of the filtration film of the small pore diameter part 2 and the vicinity of the position connected to the communication pores of the intermediate pore part 3. In addition, when all of the average pore diameter of the communication pores in a position of the surface of the filtration film in the small pore diameter part 2, the average pore diameter of the communication pores in the vicinity of the position connected to the communication pores 9 of the intermediate pore part 3 in the small pore diameter part 2 and the average pore diameter of the communication pores in the vicinity of the intermediate position between the surface of the filtration film of the small pore diameter part 2 and the vicinity of the position connected to the communication pores 9 of the intermediate pore part 3 are in the range of 4 to 20 nm, it is determined that the communication pores having an average pore diameter of 4 to 20 nm are formed from the one surface of the filtration film to the position of the vicinity of the position connected to the communication pores 9 of the intermediate pore part 3. When a distance from the straight line 41a to the straight line 41b is equal to or more than 400 nm, it is determined that the communication pores having an average pore diameter of 4 to 20 nm are formed from the one surface of the filtration film to the position of at least 400 nm. A sum of areas of communication pores 8 existing in sections made out by the straight line 41a and the straight line 41b (total area A), the number of communication pores 8 existing in sections made out by the straight line 41a and the straight line 41b (communication pore number B) and a distance of the straight line 41a and the straight line 41b (distance C) are measured. In addition, a value to be calculated according to the formula of “average pore diameter of communication pores in the whole small pore diameter part=(A/(B×C))” is an average pore diameter of communication pores in the whole small pore diameter part.

A relative standard deviation in a pore diameter distribution of communication pores in a small pore diameter part is preferably equal to or less than 40%, particularly preferably equal to or less than 35%. When the relative standard deviation in the pore diameter distribution of the communication pores in the small pore diameter part is in the above range, it is preferable in terms of making particles having an intended particle diameter to be easily captured accurately.

In the present invention, the relative standard deviation in the pore diameter distribution of the communication pores in the small pore diameter part is found based upon an SEM image obtained by observing a cross-sectional surface by cutting a particle capture filtration film in the thickness direction with a scanning electron microscope. A specific method will be explained with reference to FIG. 6. First, the straight line 41a is drawn in parallel with one surface of the filtration film in the position of the surface of the filtration film in the section of the small pore diameter part 2 on the SEM image 40, the straight line 41b is drawn in the vicinity of the position connected to the communication pores 9 of the intermediate pore part 3 on the SEM image 40, the straight line 41c is drawn in the vicinity of the intermediate position in the vicinity of the position connected to the surface of the filtration film and the communication pores 9 of the intermediate pore part 3 on the SEM image 40. Next, lengths of sections of the straight line 41a, the straight line 41b and the straight line 41c overlapping the respective communication pores 8 are each measured. A relative standard deviation is calculated from an average value of the respective measured values and the standard deviation.

An opening rate of the communication pores of the small pore diameter part on one surface of the particle capture filtration film in the present invention is preferably 10 to 50%, particularly preferably 15 to 50%. When the opening rate of the communication pores of the small pore diameter part on one surface of the particle capture filtration film is in the above range, it is preferable that more transmission water amount can be obtained and a resistance to pressure can be maintained, thus leading to less damage.

The opening rate of the communication pores of the small pore diameter part on one surface of the particle capture filtration film in the present invention is, as follows, found based upon an SEM image obtained by observing the surface of the particle capture filtration film in a side where the communication pores of the small pore diameter part open by the scanning electron microscope. First, a total area of the openings 7 of the communication pores of the small pore diameter part in the SEM image shown in FIG. 7 is measured. Next, a ratio of the total area of the openings 7 to an area of the visual field to be measured is calculated, and the calculated value is defined as the opening rate of the communication pores of the small pore diameter part on one surface of the particle capture filtration film. It should be noted that FIG. 7 is a schematic diagram of an SEM image of one surface of the particle capture filtration film.

In the particle capture filtration film of the present invention, an existing ratio (area ratio=((area of communication pores/area of small pore diameter part)×100) of the communication pores in the small pore diameter part in the SEM image of a cross-sectional surface by the scanning electron microscope is preferably 10 to 60%, particularly preferably 20 to 50%. When the existing ratio of the communication pores in the small pore diameter part in the SEM image of a cross-sectional surface by the scanning electron microscope is in the above range, it is preferable that the transmission water amount increases.

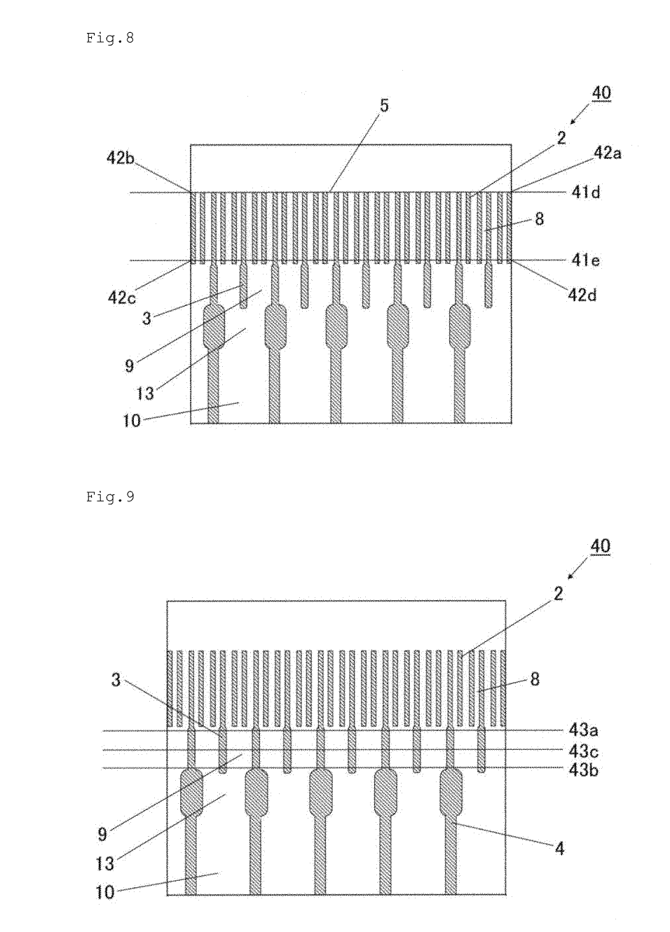

In the present invention, the existing ratio (area ratio) of the communication pores in the small pore diameter part in the SEM image of the cross-sectional surface of the particle capture filtration film is found as follows. First, a straight line 41d is drawn in parallel with one surface of a filtration film in a position on the one surface of the filtration film on the SEM image 40 shown in FIG. 8 and a straight line 41e is drawn in the vicinity of a position connected to the communication pores of the intermediate pore part 3 on the SEM image 40. An area of the small pore diameter part 2 in a section interposed between the straight line 41d and the straight line 41e, that is, areas of rectangles 42a, 42b, 42c, 42d are measured. Next, a total area of the communication pores 8 of the small pore diameter part 2 existing in the rectangles 42a, 42b, 42c, 42d is found. Next, a ratio of the total area of the communication pores 8 of the small pore diameter part 2 existing in the rectangles 42a, 42b, 42c, 42d to the area of the rectangles 42a, 42b, 42c, 42d is calculated, and the calculated value is defined as the existing ratio (area ratio) of the communication pores in the small pore diameter part in the SEM image of the cross-sectional surface of the particle capture filtration film. FIG. 8 is a schematic SEM image 40 of a cross-sectional surface of the vicinity of the surface of the particle capture filtration film as similar to that in FIG. 6.

A formation direction of the communication pores of the small pore diameter part is aligned to the thickness direction as viewed on a cross-sectional surface by cutting the communication pores in a plane in parallel with the thickness direction.

In the intermediate pore part, the communication pores having approximately the same size may be formed from the vicinity of the position to which the communication pores of the small pore diameter part are connected to the vicinity of the position connected to the large pore diameter part narrow portion of the communication pores of the large pore diameter part, or the communication pores pore diameters of which each may become larger from the vicinity of the position to which the communication pores of the small pore diameter part are connected toward the vicinity of the position connected to the large pore diameter part narrow portion of the communication pores of the large pore diameter part. A pore diameter of the communication pore of the intermediate pore part is preferably 10 to 100 nm, particularly 20 to 100 nm. A pore diameter of the communication pore of the intermediate pore part is larger than a pore diameter of the communication pores of the small pore diameter part and is smaller than a pore diameter of the large pore diameter part narrow portion of the communication pore in the large pore diameter part. A thickness of the intermediate pore part is preferably 50 to 1000 nm, particularly 50 to 800 nm.

In the present invention, for example, the confirmation that the pore diameter of the intermediate pore part is 10 to 100 nm is made based upon an SEM image obtained by observing a cross-sectional surface by cutting the particle capture filtration film in the thickness direction using a scanning electron microscope. A specific confirmation method will be explained with reference to FIG. 9. First, a straight line 43a is drawn in parallel with one surface of the filtration film in the vicinity of a position where a section of the intermediate pore part 3 is connected to the communication pores 8 of the small pore diameter part 2 on the SEM image 40, a straight line 43b is drawn in the vicinity of a position where a section of the intermediate pore part 3 is connected to the large pore diameter part narrow portion 13 of the communication pores 10 of the large pore diameter part 4, and a straight line 43c is drawn in the vicinity of a position of an intermediate position between the vicinity of a position where the communication pores 8 of the small pore diameter part 2 are connected and the vicinity of a position connected to the large pore diameter part narrow portion 13 of the communication pores 10 of the large pore diameter part 4. Next, each of lengths of sections of the straight lines, 43a, 43b, 43c overlapping the respective communication pores 9 is measured. When every length is in a range of 10 to 100 nm, it is determined that the pore diameter of the intermediate pore part is 10 to 100 nm. FIG. 9 is a schematic SEM image 40 of a cross-sectional surface in the vicinity of the surface of the particle capture filtration film as similar to that in FIG. 6.

In the large pore diameter part, the large pore diameter part narrow portion of the communication pores of the large pore diameter part is formed in the intermediate pore part side, and the communication pores having approximately the same size may be formed from the vicinity of the large pore diameter part narrow portion and the vicinity of the position closer to the opening side than the large pore diameter part narrow portion toward the other surface of the filtration film, or the communication pores pore diameters of which each may become larger from the vicinity of the large pore diameter part narrow portion and the vicinity of the position closer to the opening side than the large pore diameter part narrow portion toward the other surface of the filtration film may be formed. A pore diameter of the large pore diameter part narrow portion of the communication pore in the large pore diameter part is smaller than a pore diameter of the vicinity of the large pore diameter part narrow portion and in a section closer to the opening side than the large pore diameter part narrow portion. A pore diameter of the large pore diameter part narrow portion of the communication pore in the large pore diameter part is preferably 20 to 200 nm, particularly preferably 30 to 200 nm. Among the communication pores of the large pore diameter part, a pore diameter of the communication pores from the vicinity of the large pore diameter part narrow portion and a section closer to the opening side than the large pore diameter part narrow portion to the opening part is preferably 30 to 300 nm, particularly preferably 50 to 300 nm. When among the communication pores of the large pore diameter part, a pore diameter of the communication pores from the vicinity of the large pore diameter part narrow portion and a section closer to the opening side than the large pore diameter part narrow portion to the opening part is in the above range, a pressure loss at the liquid passing is made small.

In the present invention, for example, the confirmation that among the communication pores of the large pore diameter part, a pore diameter of the communication pores from the vicinity of the large pore diameter part narrow portion and a section closer to the opening side than the large pore diameter part narrow portion to the opening part is preferably 30 to 300 nm is, as shown below, made based upon an SEM image obtained by observing a cross-sectional surface by cutting the particle capture filtration film in the thickness direction using a scanning electron microscope. First, there is obtained an SEM image in which a formation position of the large pore diameter part narrow portion of the communication pores in the large pore diameter part to a position of the other surface of the filtration film are accommodated in the visual field to be measured. Next, a straight line X is drawn in parallel with the other surface of the filtration film in a position of the other surface of the filtration film on the SEM image, a straight line Y is drawn in the vicinity of the large pore diameter part narrow portion of a section of the large pore diameter part 4 and the vicinity of a position of a section closer to the opening side than the large pore diameter part narrow portion, and a straight line Z is drawn in the vicinity of an intermediate position between the other surface of the filtration film and the vicinity of the large pore diameter part narrow portion of a section of the large pore diameter part 4 and the vicinity of a position of a section closer to the opening side than the large pore diameter part narrow portion. Next, each of lengths of sections of the straight lines X, Y, Z overlapping the respective communication pores of the large pore diameter part is measured. When every length thereof is in a range of 30 to 300 nm, it is determined that among the communication pores of the large pore diameter part, the pore diameter of the communication pores in the opening from the vicinity of the large pore diameter part narrow portion and a section closer to the opening side than the large pore diameter part narrow portion is 30 to 300 nm.

In the present invention, for example, the confirmation that a pore diameter of the large pore diameter part narrow portion of the communication pore in the large pore diameter part is 20 to 200 nm is, as shown below, made based upon an SEM image obtained by observing a cross-sectional surface by cutting the particle capture filtration film in the thickness direction using a scanning electron microscope. First, there is obtained an SEM image in which an end of the large pore diameter part narrow portion in the intermediate pore part side to an end thereof at the opposite are accommodated in the visual field to be measured. Next, a straight line X is drawn in parallel with one surface of the filtration film in the vicinity of a position of an end of the large pore diameter part narrow portion in the intermediate pore part side on the SEM image, a straight line Y is drawn in the vicinity of a position of an end at the opposite to the end of the large pore diameter part narrow portion in the intermediate pore part side on the SEM image, and a straight line Z is drawn in the vicinity of an intermediate position between the end of the large pore diameter part narrow portion in the intermediate pore part side and the end at the opposite thereto on the SEM image. Next, each of lengths of sections of the straight lines X, Y, Z overlapping the large pore diameter part narrow portions of the respective communication pores of the large pore diameter part is measured. When every length thereof is in a range of 20 to 200 nm, it is determined that the pore diameter of the large pore diameter part narrow portion of the respective communication pore of the large pore diameter part is 20 to 200 nm.

Among the communication pores of the large pore diameter part, an average pore diameter of the communication pores from the vicinity of the large pore diameter part narrow portion and a section closer to the opening side than the large pore diameter part narrow portion to the opening part is preferably 50 to 300 nm, particularly preferably 80 to 300 nm. An average pore diameter of the large pore diameter part narrow portions of the communication pores in the large pore diameter part is preferably 20 to 300 nm, particularly preferably 30 to 200 nm.

In the present invention, among the communication pores of the large pore diameter part, an average pore diameter of the communication pores from the vicinity of the large pore diameter part narrow portion and the section closer to the opening side than the large pore diameter part narrow portion to the opening part is, as shown below, made based upon an SEM image obtained by observing a cross-sectional surface by cutting the particle capture filtration film in the thickness direction using a scanning electron microscope. It should be noted that a way of finding an average pore diameter of the communication pores from the vicinity of the large pore diameter part narrow portion and the section closer to the opening side than the large pore diameter part narrow portion to the opening part among the communication pores of the large pore diameter part shown below is, although an object to be measured is different, the same as the way of finding the average pore diameter of the communication pores in the whole small pore diameter part. First, there is obtained an SEM image in which a formation position of the large pore diameter part narrow portion to a position of the other surface of the filtration film are accommodated in the visual field to be measured. Next, a straight line X is drawn in parallel with the other surface of the filtration film in a position of the other surface of the filtration film on the SEM image, and a straight line Y is drawn in the vicinity of the large pore diameter part narrow portion of a section of the large pore diameter part 4 and the vicinity of a position of a section closer to the opening side than the large pore diameter part narrow portion. Next, a total of areas of communication pores existing in a section made out by the straight line X and the straight line Y (total area A), the number of communication pores existing in a section made out by the straight line X and the straight line Y (communication pore number B) and a distance of the straight line X and the straight line Y (distance C) are measured. In addition, a value to be calculated according to the formula of ″ an average pore diameter of the communication pores from the vicinity of the large pore diameter part narrow portion and the section closer to the opening side than the large pore diameter part narrow portion to the opening among the communication pores of the large pore diameter part=(A/(B×C)) is an average pore diameter of the communication pores from the vicinity of the large pore diameter part narrow portion and the section closer to the opening side than the large pore diameter part narrow portion to the opening among the communication pores of the large pore diameter part.

In the present invention, an average pore diameter of the large pore diameter part narrow portions of the communication pores of the large pore diameter part is, as shown below, made based upon an SEM image obtained by observing a cross-sectional surface by cutting the particle capture filtration film in the thickness direction using a scanning electron microscope. It should be noted that a way of finding an average pore diameter of the large pore diameter part narrow portions of the communication pores of the large pore diameter part shown below is, although an object to be measured is different, the same as the way of finding the average pore diameter of the communication pores in the whole small pore diameter part described above. First, there is obtained an SEM image in which an end of the large pore diameter part narrow portion in the intermediate pore part side to an end thereof at the opposite thereto are accommodated in the visual field to be measured. Next, a straight line X is drawn in parallel with one surface of the filtration film in the vicinity of the end of the large pore diameter part narrow portion in the intermediate pore part side on the SEM image, and a straight line Y is drawn in the vicinity of the end at the opposite to the end of the large pore diameter part narrow portion in the intermediate pore part side on the SEM image. Next, a total of areas of communication pores existing in a section made out by the straight line X and the straight line Y (total area A), the number of communication pores existing in a section made out by the straight line X and the straight line Y (communication pore number B) and a distance of the straight line X and the straight line Y (distance C) are measured. In addition, a value to be calculated according to the formula of ″ an average pore diameter of the large pore diameter part narrow portion of the communication pore of the large pore diameter part=(A/(B×C)) is an average pore diameter of the large pore diameter part narrow portion of the communication pore of the large pore diameter part.

In the particle capture filtration film of the present invention, a ratio of an average pore diameter of the communication pores from the vicinity of the large pore diameter part narrow portion and the section closer to the opening side than the large pore diameter part narrow portion to the opening among the communication pores of the large pore diameter part to an average pore diameter of the communication pores of the whole small pore diameter part (an average pore diameter of the communication pores from the vicinity of the large pore diameter part narrow portion and the section closer to the opening side than the large pore diameter part narrow portion to the opening among the communication pores of the large pore diameter part/an average pore diameter of the communication pores of the whole small pore diameter part) is preferably 3 to 100, particularly preferably 4 to 50, and more preferably 4 to 20. When a ratio of an average pore diameter of the communication pores from the vicinity of the large pore diameter part narrow portion and the section closer to the opening side than the large pore diameter part narrow portion to the opening among the communication pores of the large pore diameter part to an average pore diameter of the communication pores of the whole small pore diameter part is in the above range, the particle capture filtration film of the present invention is preferable in terms of being strong to stress and difficult to be damaged.

A thickness of the large pore diameter part is preferably 10 to 40 μm, particularly preferably 20 to 40 μm.

A total film thickness of the particle capture filtration film of the present invention is equal to or less than 50 μm, preferably 20 to 50 μm, particularly preferably 20 to 45 μm. When the total film thickness of the particle capture filtration film is in the above range, at the time of firing the anodized section obtained by the anode oxidization, the separation and the etching treatment, the damage of the anodized section is made a little.

The particle capture filtration film of the present invention is a particle capture filtration film obtained by forming communication pores by the anode oxidization of an aluminum material, in more detail, a particle capture filtration film obtained by forming communication pores by the anode oxidization of an aluminum material, next, separating the anodized section from the aluminum material, next, executing surface etching treatment to the anodized section, and firing the anodized section. Therefore a skeleton part of the particle capture filtration film of the present invention, in other words, walls of the communication pores of the small pore diameter part, the communication pores of the intermediate pore part and the communication pores of the large pore diameter part are formed with oxidized aluminum.

At the time of extracting the communication pores of the intermediate pore part and the communication pores of the large pore diameter part in the particle capture filtration film of the present invention at a random and comparing these pore diameters, there exist some communication pores of the intermediate pore part which are larger in pore diameter than the communication pores of the large pore diameter part. In addition, at the time of extracting the communication pores from the vicinity of the large pore diameter part narrow portion and the section closer to the opening side than the large pore diameter part narrow portion to the opening and the large pore diameter part narrow portions among the communication pores of the large pore diameter part in the particle capture filtration film of the present invention at a random and comparing these pore diameters, there exist some large pore diameter part narrow portions having sections which are larger in pore diameter than the communication pores from the vicinity of the large pore diameter part narrow portion and the section closer to the opening side than the large pore diameter part narrow portion to the opening. On the other hand, at the time of comparing pore diameters of the communication pores from the vicinity of the large pore diameter part narrow portion and the section closer to the opening side than the large pore diameter part narrow portion to the opening among the communication pores of a series of large pore diameter parts forming continuous flow paths from one surface side to the other surface side in the particle capture filtration film of the present invention with pore diameters of the large pore diameter part narrow portion, the communication pores of the intermediate pore part and the communication pores of the small pore diameter part. Since the particle capture filtration film of the present invention is a particle capture filtration film obtained by forming communication pores by the anode oxidization of an aluminum material, in one large pore diameter part the communication pores of the large pore diameter part are smaller in pore diameter than the communication pores from the vicinity of the large pore diameter part narrow portion and the section closer to the opening side than the large pore diameter part narrow portion to the opening, and communication pores of the intermediate pore part a pore diameter of which is smaller than a pore diameter of the large pore diameter part narrow portion are connected to the large pore diameter part narrow portion, and communication pores of the small pore diameter part a pore diameter of which is smaller than a pore diameter of the intermediate pore part are connected to the intermediate pore part.

The particle capture filtration film of the present invention is used suitably as a particle capture filtration film for particle evaluation by direct microscopy of ultrapure water, solvents, medical agents and the like to be used in the semiconductor manufacture. In addition, the particle capture filtration film of the present invention is also used for capture of gases and aerosol, particles in the other fluid, and separation and capture of protein materials and DNA.

The particle capture filtration film of the present invention is manufactured preferably by manufacturing methods of the particle capture filtration film of the present invention as follows.

A manufacturing method of a particle capture filtration film according to a first embodiment of the present invention includes:

a first anode oxidization process (A) of anodizing an aluminum material to form a progenitor communication pore of a communication pore for a large pore diameter part on the aluminum material and obtain an anode oxidization aluminum material (1A);

pore diameter enlarging treatment of immersing the anode oxidization aluminum material (1A) in any aqueous solution of an oxalic acid aqueous solution, a chromic acid aqueous solution, a phosphoric acid aqueous solution, a sulfuric acid aqueous solution, a mixed acid aqueous solution of them or an alkaline aqueous solution to enlarge a diameter of the progenitor communication pore and form the communication pore for the large pore diameter part;

a second anode oxidization process (A) of anodizing the anode oxidization aluminum material (1A) subjected to pore diameter enlarging treatment to form a large pore diameter part narrow portion smaller in diameter than the communication pore for the large pore diameter part on an end of the communication pore for the large pore diameter part in the anode oxidization aluminum material (1A) subjected to the pore diameter enlarging treatment and obtain an anode oxidization aluminum material (2);

a third anode oxidization process of anodizing the anode oxidization aluminum material (2) to form a communication pore for an intermediate pore part that is connected to the large pore diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);

a fourth anode oxidization process of anodizing the anode oxidization aluminum material (3) to form a communication pore for a small pore diameter part that is connected to the communication pore for the intermediate pore part and is smaller in diameter than the communication pore for the intermediate pore part and obtain an anode oxidization aluminum material (4);

a separation and etching process of separating an anodized section from the anode oxidization aluminum material (4) and next, executing etching treatment to the separated section to obtain an anodized section; and

a calcination process of firing the anodized section at a temperature of 800 to 1200° C. to obtain a particle capture filtration film, wherein

in the fourth anode oxidization process, the communication pores having an average pore diameter of 4 to 20 nm are formed in a range of 400 nm or more in a thickness direction, and

from the first anode oxidization process to the fourth anode oxidization process, a total thickness of sections on which the communication pores are formed by the anode oxidization is equal to or less than 50 μm.

A manufacturing method of a particle capture filtration film according to a second embodiment of the present invention includes:

a first anode oxidization process (B) of anodizing an aluminum material to form a communication pore for a large pore diameter part on the aluminum material and obtain an anode oxidization aluminum material (1B);

a second anode oxidization process (B) of anodizing the anode oxidization aluminum material (1B) to form a large pore diameter part narrow portion smaller in diameter than the communication pore for the large pore-diameter part on an end of the communication pore for the large pore diameter part in the anode oxidization aluminum material (1B) and obtain an anode oxidization aluminum material (2);

a third anode oxidization process of anodizing the anode oxidization aluminum material (2) to form a communication pore for an intermediate pore part that is connected to the large pore diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);

a fourth anode oxidization process of anodizing the anode oxidization aluminum material (3) to form a communication pore for a small pore diameter part that is connected to the communication pore for the intermediate pore part and is smaller in diameter than the communication pore for the intermediate pore part and obtain an anode oxidization aluminum material (4);

a separation and etching process of separating an anodized section from the anode oxidization aluminum material (4) and next, executing etching treatment to the separated section to obtain an anodized section; and

a calcination process of firing the anodized section at a temperature of 800 to 1200° C. to obtain a particle capture filtration film, wherein

in the fourth anode oxidization process, the communication pores having an average pore diameter of 4 to 20 nm are formed in a range of 400 nm or more in a thickness direction, and

from the first anode oxidization process to the fourth anode oxidization process, a total thickness of sections on which the communication pores are formed by the anode oxidization is equal to or less than 50 μm.

That is, the third anode oxidization process, the fourth anode oxidization process, the separation and etching process, and the calcination process according to the manufacturing method of the particle capture filtration film according to the first embodiment of the present invention are similar to the third anode oxidization process, the fourth anode oxidization process, the separation and etching process, and the calcination process according to the manufacturing method of particle capture filtration film according to the second embodiment of the present invention.

The first anode oxidization process (1A) according to the manufacturing method of the particle capture filtration film according to the first embodiment of the present invention is a process of obtaining the anode oxidization aluminum material (1A) by anodizing an aluminum material to form progenitor communication pores of communication pores for a large pore diameter part on the aluminum material.

The aluminum material according to the first anode oxidization process (A) is a material to be anodized in the first anode oxidization process (A), is a material composed primarily of aluminum, and particularly not limited, when many impurities are contained in the aluminum, defects tend to be easily created at manufacturing. Therefore a degree of purity of the aluminum material is preferably equal to or more than 98.5 mass %, particularly preferably equal to or more than 99.0 mass %.

In the first anode oxidization process (A), it is preferable that a surface of the aluminum material to be anodized is in advance subjected to degreasing treatment and smoothing treatment. A method of executing the degreasing treatment is not particularly limited as long as the method can remove organic substances and fats present on the surface of the aluminum material, and includes methods such as a method of immersing an aluminum material in an organic solvent of acetone, ethanol, methanol, IPA (isopropyl alcohol) or the like to be irradiated with a supersonic wave or to be heated (be subjected to anneal treatment). A method of executing the smoothing treatment is not particularly limited as long as the method can smooth a surface of the aluminum material, and includes methods such as electrolytic polishing, chemical polishing, mechanical polishing. An electrolytic solution of the electrolytic polishing includes ethanol containing phosphoric acid or perchloric acid. The chemical polishing includes methods of using mixing of a phosphoric acid and a nitric acid, using a mixing acid of a phosphoric acid and a sulfuric acid and the like.

In the first anode oxidization process (A), an anodizing condition at the time of anodizing the aluminum material are optionally selected depending upon communication pores for the large pore diameter part in the particle capture filtration film to be obtained, and a voltage to be applied, a current to be supplied, an applying time, a kind of an electrolytic solution and the like are optionally selected to form progenitor communication pores of the communication pores for the large pore diameter part in the particle capture filtration film to be intended. The anodizing condition in the first anode oxidization process (A) includes a condition of 50 to 200 V in the electrolytic solution of an oxalic acid aqueous solution, a chromic acid aqueous solution of 0.5 to 30 mass % density or a mixed acid aqueous solution thereof, and the like. At this time, this process may use a system with a constant voltage, a constant current or varying both of the voltage and current.

In the first anode oxidization process (A), as the progenitor communication pores of the communication pores for the large pore diameter part to be formed on the aluminum material by the anode oxidization, a pore diameter of the progenitor communication pores of the communication pores for the large pore diameter part is preferably 20 to 200 nm, particularly preferably 30 to 200 nm and an average pore diameter of the progenitor communication pores is preferably 20 to 200 nm, particularly preferably 30 to 200 nm, and a thickness of a section in which the progenitor communication pores are formed is preferably 10 to 40 μm, particularly preferably 20 to 40 μm.

In addition, when the first anode oxidization process (A) is executed, communication pores are formed from the surface of the aluminum material in the thickness direction and progenitor communication pores of the communication pores for the large pore diameter part extending in the thickness direction from the surface of the aluminum material are formed in the aluminum material, thus making it possible to obtain the anode oxidization aluminum material (1A).

The pore diameter enlarging treatment according to the manufacturing method of the particle capture filtration film according to the first embodiment of the present invention is treatment of immersing the anode oxidization aluminum material (1A) in an oxalic acid aqueous solution, a chromic acid aqueous solution, a phosphoric acid aqueous solution, a sulfuric acid aqueous solution, a mixed acid aqueous solution of them or an alkaline aqueous solution of sodium hydroxide or the like to enlarge a diameter of the progenitor communication pore and form the communication pores for the large pore diameter part. As to the solution to be used in the pore diameter enlarging treatment, the same solution with the electrolytic solution used in the first anode oxidization process (A) or the same kind of acid solution is preferable. It should be noted that the communication pores for the large pore diameter part is a communication pore as the communication pore of the large pore diameter part in the particle capture filtration film to be obtained through until the calcination process. The same solution with the electrolytic solution used in the first anode oxidization process (A) is the solution having the same acid kind and the same density, and the solution of the same acid with the electrolytic solution used in the first anode oxidization process (A) is the solution which has the same acid kind but differs in density.

In the pore diameter enlarging process, the treatment condition in the first anode oxidization process (A) is optionally selected depending upon communication pores of the large pore diameter part in the particle capture filtration film to be obtained, and a density of the solution, an immersion temperature, an immersion time and the like are optionally selected to form communication pores for the large pore diameter part to be intended. The treatment condition in the pore diameter enlarging process includes a condition of 30 minutes to eight hours at 10 to 80° C. in an oxalic acid aqueous solution or a chromic acid aqueous solution of 0.5 to 30 mass % density, in a mixed acid aqueous solution thereof, and the like, or in a sodium hydroxide solution.

In the pore diameter enlarging treatment, as to the communication pores for the large pore diameter part formed by enlarging the progenitor communication pores of the communication pores for the large pore diameter part in the anode oxidization aluminum material (1A) by immersing the anode oxidization aluminum material (1A) in the solution, a pore diameter of the communication pores for the large pore diameter part is preferably 30 to 300 nm, particularly preferably 50 to 300 nm and an average pore diameter of the communication pores for the large pore diameter part is preferably 50 to 300 nm, particularly preferably 80 to 30 nm, and a thickness of a section corresponding to the large pore diameter part is preferably 10 to 40 μm, particularly preferably 20 to 40 μm.

In addition, when the pore diameter enlarging treatment is executed, a pore diameter of the progenitor communication pores of the communication pores for the large pore diameter part are enlarged to form the communication pores for the large pore diameter part extending in the thickness direction from the surface of the aluminum material, thus making it possible to obtain the anode oxidization aluminum material (1A) subjected to the pore diameter enlarging treatment.

The second anode oxidization process (A) according to the manufacturing method of the first particle capture filtration film of the present invention is a process of obtaining the anode oxidization aluminum material (2) by anodizing the anode oxidization aluminum material (1A) subjected to the pore diameter enlarging treatment to form the large pore diameter part narrow portion on an end of the communication pores for the large pore diameter part in the anode oxidization aluminum material (1A) subjected to the pore diameter enlarging treatment.

In the second anode oxidization process (A), an anodizing condition at the time of anodizing the aluminum material are optionally selected depending upon the large pore diameter part narrow portion of the communication pores of the large pore diameter part in the particle capture filtration film to be obtained, and a voltage to be applied, a current to be supplied, an applying time, a kind of an electrolytic solution and the like are optionally selected to form the large pore diameter part narrow portion of the communication pores for the large pore diameter part in the particle capture filtration film to be intended. The anodizing condition in the second anode oxidization process (A) includes a condition of 50 to 200 V in the electrolytic solution of an oxalic acid aqueous solution, a chromic acid aqueous solution of 0.5 to 30 mass % density, a mixed acid aqueous solution thereof, or the like. At this time, this process may use a system with a constant voltage, a constant current or varying both of the voltage and current.

In the second anode oxidization process (A), as to the large pore diameter part narrow portion of the communication pores for the large pore diameter part to be formed on the aluminum material by the anode oxidization, a pore diameter of the large pore diameter part narrow portion of the communication pores for the large pore diameter part is preferably 20 to 200 nm, particularly preferably 30 to 200 nm and an average pore diameter of the large pore diameter part narrow portion is preferably 20 to 200 nm, particularly preferably 30 to 200 nm, and a thickness of a section in which the large pore diameter part narrow portion is formed is preferably 500 nm to 20 μm, particularly preferably 500 to 10 μm.

In addition, the second anode oxidization process (A) is executed to form the large pore diameter part narrow portion in the thickness direction from an end of the communication pores for the large pore diameter part, thus making it possible to obtain the anode oxidization aluminum material (2).

The first anode oxidization process (B) according to the manufacturing method of the particle capture filtration film according to the second embodiment of the present invention is a process of obtaining the anode oxidization aluminum material (1B) by anodizing an aluminum material to form communication pores for the large pore diameter part on the aluminum material. It should be noted that the communication pores for the large pore diameter part are communication pores as communication pores for the large pore diameter part in the particle capture filtration film to be obtained through to the calcination process.

The aluminum material according to the first anode oxidization process (B) is a material to be anodized in the first anode oxidization process (B), and is similar to the aluminum material according to the first anode oxidization process (A).

In the first anode oxidization process (B), it is preferable that a surface of the aluminum material to be anodized is in advance subjected to degreasing treatment and smoothing treatment. The degreasing treatment and the smoothing treatment according to the first anode oxidization process (B) are similar to the degreasing treatment and the smoothing treatment in the first anode oxidization process (A).

In the first anode oxidization process (B), an anodizing condition at the time of anodizing the aluminum material are optionally selected depending upon the communication pores of the large pore diameter part in the particle capture filtration film to be obtained, and a voltage to be applied, a current to be supplied, an applying time, a kind of an electrolytic solution and the like are optionally selected to form the communication pores for the large pore diameter part in the particle capture filtration film to be intended. The anodizing condition in the first anode oxidization process (B) includes a condition of 50 to 200 V in the electrolytic solution of an oxalic acid aqueous solution and a chromic acid aqueous solution of 0.5 to 30 mass % density, a mixed acid aqueous solution thereof, or the like. At this time, this process may use a system with a constant voltage, a constant current or varying both of the voltage and current.

In the first anode oxidization process (B), as to the communication pores for the large pore diameter part to be formed on the aluminum material by the anode oxidization, a pore diameter of the communication pores for the large pore diameter part is preferably 30 to 300 nm, particularly preferably 50 to 300 nm and an average pore diameter of the communication pores for the large pore diameter part is preferably 50 to 300 nm, particularly preferably 80 to 300 nm, and a thickness of a section of the communication pores for the large pore diameter part is preferably 10 to 40 μm, particularly preferably 20 to 40 μm.

In addition, when the first anode oxidization process (B) is executed, communication pores are formed from the surface of the aluminum material in the thickness direction and the communication pores for the large pore diameter part extending in the thickness direction from the surface of the aluminum material are formed in the aluminum material, thus making it possible to obtain the anode oxidization aluminum material (1B).

The second anode oxidization process (B) according to the manufacturing method of the second particle capture filtration film of the present invention is a process of obtaining the anode oxidization aluminum material (2) by anodizing the anode oxidization aluminum material (1B) to form the large pore diameter part narrow portion on an end of the communication pores for the large pore diameter part in the anode oxidization aluminum material (1B).

In the second anode oxidization process (B), an anodizing condition at the time of anodizing the aluminum material is optionally selected depending upon the large pore diameter part narrow portion of the communication pores of the large pore diameter part in the particle capture filtration film to be obtained, and a voltage to be applied, a current to be supplied, an applying time, a kind of an electrolytic solution and the like are optionally selected to form the large pore diameter part narrow portion of the communication pores for the large pore diameter part in the particle capture filtration film to be intended. The anodizing condition in the second anode oxidization process (B) includes, for example, a condition of 20 to 200 V in the electrolytic solution of an oxalic acid aqueous solution, a chromic acid aqueous solution and a sulfuric acid of 0.5 to 30 mass % density, a mixed acid aqueous solution thereof, or the like. At this time, this process may use a system with a constant voltage, a constant current or varying both of the voltage and current.

In the second anode oxidization process (B), as to the large pore diameter part narrow portion of the communication pores for the large pore diameter part to be formed on the aluminum material by the anode oxidization, a pore diameter of the large pore diameter part narrow portion of the communication pores for the large pore diameter part is preferably 20 to 200 nm, particularly preferably 30 to 200 nm and an average pore diameter of the large pore diameter part narrow portion is preferably 20 to 200 nm, particularly preferably 30 to 200 nm, and a thickness of a section in which the large pore diameter part narrow portion is formed is preferably 500 nm to 20 μm, particularly preferably 500 to 10 μm.

In addition, the second anode oxidization process (B) is executed to form the large pore diameter part narrow portion in the thickness direction from an end of the communication pores for the large pore diameter part, thus making it possible to obtain the anode oxidization aluminum material (2).

The manufacturing method of the particle capture filtration film according to the first embodiment of the present invention and the manufacturing method of the particle capture filtration film according to the second embodiment of the present invention are the same after the third anode oxidization process, and therefore will be explained all together.

The third anode oxidization process according to the manufacturing method of the particle capture filtration film according to the first embodiment of the present invention and according to the manufacturing method of the particle capture filtration film according to the second embodiment of the present invention is a process of obtaining the anode oxidization aluminum material (3) by anodizing an aluminum material (2) to form communication pores for the intermediate pore part on the anode oxidization aluminum material (2). It should be noted that the communication pores for the intermediate pore part are communication pores as communication pores for the intermediate pore part in the particle capture filtration film to be obtained through to the calcination process.

In the third anode oxidization process, an anodizing condition at the time of anodizing an anode oxidization aluminum material (2) is optionally selected depending upon the communication pores of the intermediate pore part in the particle capture filtration film to be obtained, and a voltage to be applied, a current to be supplied, an applying time, a kind of an electrolytic solution and the like are optionally selected to form the communication pores for the intermediate pore part to be intended. The anodizing condition in the third anode oxidization process may include a condition in which communication pores smaller in diameter than the large pore diameter part narrow portion of the communication pores for the large pore diameter part is formed, for example, a condition of 20 to 200 V in the electrolytic solution of an oxalic acid aqueous solution, a chromic acid aqueous solution and sulfuric acid of 0.5 to 30 mass % density, a mixed acid aqueous solution thereof, or the like, preferably a condition of a voltage lower than a voltage of the second anode oxidization condition. At this time, this process may use a system with a constant voltage, a constant current or varying both of the voltage and current.

In the third anode oxidization process, the communication pores for the intermediate pore part to be formed on the anode oxidization aluminum material (2) by the anode oxidization have a pore diameter of the communication pores for the intermediate pore part is preferably 10 to 100 nm, particularly preferably 20 to 100 nm and a thickness of a section corresponding to the intermediate pore part is preferably 50 to 1000 nm, particularly preferably 50 to 800 nm.

In addition, when the third anode oxidization process is executed, communication pores smaller in pore diameter than the large pore diameter part narrow portion of the communication pores for the large pore diameter part are formed in the thickness direction from the end of the large pore diameter part narrow portion of the communication pores for the large pore diameter part in the anode oxidization aluminum material (2), and communication pores for the intermediate pore part extending in the thickness direction from the end of the large pore diameter part narrow portion of the communication pores for the large pore diameter part in the anode oxidization aluminum material (2) are formed in the anode oxidization aluminum material (2), thus making it possible to obtain the anode oxidization aluminum material (3).

The fourth anode oxidization process according to the manufacturing method of the particle capture filtration film according to the first embodiment of the present invention and according to the manufacturing method of the particle capture filtration film according to the second embodiment of the present invention is a process of obtaining the anode oxidization aluminum material (4) by anodizing an anode oxidization aluminum material (3) to form communication pores for the small pore diameter part on the anode oxidization aluminum material (3). It should be noted that the communication pores for the small pore diameter part are communication pores as the communication pores for the small pore diameter part in the particle capture filtration film to be obtained through to the calcination process.

In the fourth anode oxidization process, an anodizing condition at the time of anodizing an anode oxidization aluminum material (3) is optionally selected depending upon the communication pores of the small pore diameter part in the particle capture filtration film to be obtained, and a voltage to be applied, a current to be supplied, an applying time, a kind of an electrolytic solution and the like are optionally selected to form the communication pores for the small pore diameter part to be intended. The anodizing condition in the fourth anode oxidization process may include a condition in which the communication pores having an average pore diameter which is 4 to 20 nm, preferably 8 to 20 nm, particularly preferably 9 to 15 nm, more preferably 9 to 12 nm, and have 400 nm or more, preferably 400 to 1000 nm, particularly preferably 400 to 700 nm in the thickness direction are formed. For example, the condition may include a condition of 5 to 30 V in the sulfuric acid aqueous solution electrolytic solution. At this time, the anode oxidization may be executed in a system with a constant voltage, a constant current or varying both of the voltage and current.

In the fourth anode oxidization process, the communication pores for small pore diameter part are formed on the anode oxidization aluminum material (3) by the anode oxidization, having an average pore diameter of 4 to 20 nm, preferably 8 to 20 nm, particularly preferably 9 to 15 nm, more preferably 9 to 12 nm, and having 400 nm or more, preferably 400 to 1000 nm, particularly preferably 400 to 700 nm in the thickness direction. When the average pore diameter of the communication pores for small pore diameter part is in the above range, the particle capture filtration film achieving the excellent performance can be obtained as the particle capture filtration film to be used in direct microscopy. In addition, when a thickness of a section corresponding to the small pore diameter part is 400 nm or more, damage of the communication pores in the section corresponding to the small pore diameter part of the anode oxidization section to be obtained by executing the separation process is made a little. In addition, when a thickness of the section corresponding to the small pore diameter is 1000 nm or less, it is preferable that at the liquid passing, the particle capture filtration film in which a transmission flow amount by the pressure loss is not too low can be obtained.

In the fourth anode oxidization process, the communication pores for the small pore diameter part to be formed on the anode oxidization aluminum material (3) by the anode oxidization have an average pore diameter of the communication pores of the whole section corresponding to the small pore diameter part which is 4 to 20 nm, preferably 8 to 20 nm, particularly preferably 9 to 15 nm, more preferably 9 to 12 nm, and a relative standard deviation in the pore diameter distribution of the communication pores for the small pore diameter part which is preferably 40% or less, particularly preferably 35%, and an existing ratio (area ratio) of the communication pores in the section corresponding to the small pore diameter part in the SEM image in section which is preferably 10 to 60%, particularly preferably 20 to 50%.

In addition, when the fourth anode oxidization process is executed, communication pores smaller in pore diameter than the communication pores for the intermediate pore part are formed in the thickness direction from the end of the communication pores for the intermediate pore part in the anode oxidization aluminum material (3), and communication pores for the small pore diameter part extending in the thickness direction from the end of the communication pores for the intermediate pore part in the anode oxidization aluminum material (3) are formed in the anode oxidization aluminum material (3), thus making it possible to obtain the anode oxidization aluminum material (4).

In the first anode oxidization process, in the second anode oxidization process, in the third anode oxidization process and in the fourth anode oxidization process, each of the anode oxidization conditions in the first anode oxidization process, in the second anode oxidization process, in the third anode oxidization process and in the fourth anode oxidization process, that is, a voltage to be applied, a current to be supplied, an applying time, a kind of an electrolytic solution and the like are respectively adjusted to form the respective communication pores of the small pore diameter part, the intermediate pore part and the large pore diameter part and the large pore diameter part narrow portion in shape to be intended in response to shapes of the respective communication pores of the small pore diameter part, the intermediate pore part and the large pore diameter part and the large pore diameter part narrow portion in the particle capture filtration film to be obtained.

Each of the anode oxidization conditions in the first anode oxidization process, in the second anode oxidization process, in the third anode oxidization process and in the fourth anode oxidization process is adjusted such that a total thickness of sections in which communication pores are formed from the first anode oxidization process to the fourth anode oxidization process is 50 μm or less, preferably 20 to 50 μm, particularly preferably 20 to 45 μm. When the total thickness of the sections in which the communication pores are formed from the first anode oxidization process to the fourth anode oxidization process is in the above range, damage of the anodized section is made less at the time of firing the anode oxidization at the firing process.

The separation and etching process according to the manufacturing method of the particle capture filtration film according to the first embodiment of the present invention and according to the manufacturing method of the particle capture filtration film according to the second embodiment of the present invention is a process of obtaining the anode oxidization section by separating a section anodized from the anode oxidization aluminum material (4) and executing etching treatment to a surface of the separated section.

In the separation and etching process, the method of separating the section anodized from the anode oxidization aluminum material (4) may, particularly not limited, and include, for example, solution immersion, reverse current method, electrolytic polishing or the like. The solution immersion is executed by immersing the anode oxidization aluminum material (4) in the cupric sulfuric acid aqueous solution, a hydrochloric acid or the like, and is a method of requiring a long time for the separation but having less physical damages. The reverse current method is executed by flowing the current at oxidizing in reverse and can quickly separate the anodized section from the anode oxidization aluminum material (4). The electrolytic polishing is executed by applying a voltage to the anode oxidization material (4) in the perchloric acid ethanol solution or in the perchloric acid diacetone solution, and can quickly separate the anodized section from the anode oxidization aluminum material (4).

In the separation and etching process, the method of executing the etching treatment to the surface of the separated anodized section includes, particularly not limited, for example, a method of immersing the anode oxidization aluminum material (4) in the solution such as an oxalic acid aqueous solution, a chromic acid aqueous solution, a phosphoric acid aqueous solution, sulfuric acid aqueous solution or an alkaline aqueous solution, or the like.

The etching treatment is executed to etch the surface of the section separated from the aluminum material to form communication pores for the large pore diameter part and the large pore diameter part narrow portion, communication pores for the intermediate pore part and communication pores for the small pore diameter part, thus making it possible to obtain anodized sections as through films penetrating more therein.

The calcination process according to the manufacturing method of the particle capture filtration film according to the first embodiment of the present invention and according to the manufacturing method of the particle capture filtration film according to the second embodiment of the present invention is a process of obtaining a particle capture filtration film by firing the anodized section.

In the calcination process, a calcination temperature at the time of firing the anodized section is 800 to 1200° C., preferably 800 to 1000° C. In addition, in the calcination process, a calcination time at the time of firing the anodized section is preferably 10 hours or less, particularly preferably 1 to 5 hours. In the calcination process, a calcination atmosphere at the time of firing the anodized section is an oxidized atmosphere of air, an oxygen gas or the like.

The communication pores in the particle capture filtration film of the present invention are formed from the large pore diameter part to the small pore diameter part by the anode oxidization. That is, first, communication pores for the large pore diameter part are formed on the aluminum material by the anode oxidization, next, the large pore diameter part narrow portion is formed on an end of the communication pore for the large pore diameter part, next, a communication pore for the intermediate pore part is formed from an end of the communication pore for the large pore diameter part, and next, a communication pore for the small pore diameter part is formed from an end of the communication pore for the intermediate pore part. Since the communication pores are formed in the above order, all the communication pores from one surface side of the filtration film to the other surface side are connected.

In the particle capture filtration film of the present invention, the communication pores of the large pore diameter part larger in pore diameter are disposed on the other surface side for reducing a pressure difference at the time of passing a measurement object liquid. Here, if the communication pore of the large pore diameter part does not have the large pore diameter part narrow portion on the intermediate pore part side and the communication pore of the intermediate pore part is directly connected to a section of the communication pore of the large pore diameter part larger in pore diameter in the particle capture filtration film, a pore diameter difference between the communication pore of the intermediate pore part and the communication pore of the large pore diameter part is too large. Therefore when the measurement object liquid passes from the communication pore of the intermediate pore part to the communication pore of the large pore diameter part, the pressure change is too large. Therefore the measurement object liquid adjusted in the communication pores of the intermediate pore part becomes a disturbed flow in the sections of the communication pores of the large pore diameter part immediately after passing the communication pores of the intermediate pore part, and even if the pore diameter of the communication pore of the large pore diameter part is made large, there is a possibility that the pressure loss becomes large in reverse. An impact at the time the measurement object liquid passes from the communication pore of the intermediate pore part to the communication pore of the large pore diameter part possibly damages the particle capture filtration film.

In contrast, in the particle capture filtration film of the present invention, communication pores of the large pore diameter part larger in pore diameter are disposed on the other surface side for reducing a pressure difference at the time of passing the measurement object liquid, and the communication pores of the large pore diameter part have a large pore diameter part narrow portion on the intermediate pore part side. In the particle capture filtration film of the present invention, the communication pore of the intermediate pore part is connected to the large pore diameter part narrow portion smaller in pore diameter than the communication pore from the vicinity of the large pore diameter part narrow portion and the section closer to the opening side than the large pore diameter part narrow portion to the opening. Therefore as compared to a case where the communication pore of the intermediate pore part is connected directly to a section of the communication pore of the large pore diameter part, a change in pressure is small at the time the measurement object liquid passes from the communication pore of the intermediate pore part through the large pore diameter part narrow portion. Thereby in the particle capture filtration film of the present invention, the measurement object liquid adjusted in the communication pores of the intermediate pore part is difficult to become a disturbed flow or the degree can be made small at the time of passing from the communication pore of the intermediate pore part to the large pore diameter part narrow portion. Therefore the pressure loss can be made small. Since it is possible to reduce an impact at the time the measurement object liquid passes from the communication pore of the intermediate pore part, the particle capture filtration film is difficult to be damaged.

In addition, the particle capture filtration film shown in FIG. 13 has partially a section where directions of forming communication pores of the small pore diameter part are not aligned and the communication pores are formed to widen in a fan shape. When there is the section where the communication pore is formed in the fan shape, in some cases the measurement object liquid is difficult to be normally transmitted in the communication pore or the section where the communication pore is formed in the fan shape becomes a swollen section of a film surface after etching. On the other hand, in the manufacturing method of the particle capture filtration film of the present invention, since the directions of forming the communication pores of the small pore diameter part can be aligned in the thickness direction, the small pore diameter part where the directions of forming all the communication pores are aligned can be formed on a cross-sectional surface by cutting with a plane in parallel with the thickness direction.

In addition, in a case of using an oxalic acid aqueous solution as an electrolytic solution, it is difficult to form communication pores large in pore diameter, having a pore diameter of 100 nm or more, on an aluminum material by the anode oxidization, it is required to use a phosphoric acid aqueous solution as the electrolytic solution for forming the communication pore of 100 nm or more. However, after forming the communication pore of the large pore diameter part using the phosphoric acid aqueous solution as the electrolytic solution, even if the large pore diameter part narrow portion is formed by the anode oxidization by changing the electrolytic solution for the phosphoric acid aqueous solution, or after forming the communication pore of the large pore diameter part and the large pore diameter part narrow portion using the phosphoric acid aqueous solution as the electrolytic solution, even if the communication pores of the intermediate pore part are formed by the anode oxidization by changing the electrolytic solution for the phosphoric acid aqueous solution, since replacement of the electrolytic solution for the oxalic acid aqueous solution is difficult to be made, the anode oxidization after that cannot be executed. On the other hand, in the manufacturing method of the particle capture filtration film according to the first embodiment of the present invention, after anodizing communication pores of the large pore diameter part large in pore diameter, having a pore diameter of 100 nm or more, using an oxalic acid aqueous solution as the electrolytic solution, the communication pores of the large pore diameter part large are formed by the pore diameter enlarging treatment using the oxalic acid aqueous solution. Therefore it is possible to excellently execute the second anode oxidization process (A) of forming the large pore diameter part narrow portion using the oxalic acid aqueous solution as the electrolytic solution without any problem caused by such replacement failure from the phosphoric acid aqueous solution to the oxalic acid aqueous solution.

A porous film according to the present invention is a porous film obtained by forming communication pores by anode oxidization of an aluminum material, including:

a small pore diameter part having communication pores formed to open to one surface of the porous film;

an intermediate pore part having communication pores to which the communication pores of the small pore diameter part are connected and which are larger in diameter than a diameter of the communication pores in the small pore diameter part; and

a large pore diameter part having communication pores to which communication pores of an intermediate pore part are connected and which are larger in diameter than the communication pores in the intermediate pore part and are formed to open to the other surface of the porous film, wherein

the small pore diameter part is provided with the communication pores formed from the one surface of the porous film to a position of at least 400 nm, the communication pores having an average pore diameter of 4 to 20 nm,

a total film thickness of the porous film is equal to or less than 50 μm, and

the communication pores of the large pore diameter part have a large pore diameter part narrow portion in the intermediate pore part side.

The aluminum material, the anode oxidization, the communication pore, the small pore diameter part, the intermediate pore part, the large pore diameter part and the large pore diameter part narrow portion according to the porous film of the present invention are similar to the aluminum material, the anode oxidization, the communication pore, the small pore diameter part, the intermediate pore part, the large pore diameter part and the large pore diameter part narrow portion according to the particle capture filtration film of the present invention

An application example of the porous film of the present invention includes, other than the particle capture filtration film, an enzyme carrier for fixing enzyme by an enzyme electrode or the like, a carbon material, a casting mold of semiconductor wiring, an additive filter for adding a solvent or a solvent medium by an ultralow amount.

A manufacturing method of a porous film according to a first embodiment of the present invention includes:

a first anode oxidization process (A) of anodizing an aluminum material to form a progenitor communication pore of a communication pore for a large pore diameter part on the aluminum material and obtain an anode oxidization aluminum material (1A);

pore diameter enlarging treatment of immersing the anode oxidization aluminum material (1A) in any aqueous solution of an oxalic acid aqueous solution, a chromic acid aqueous solution, a phosphoric acid aqueous solution, sulfuric acid aqueous solution, a mixed acid aqueous solution of them or an alkaline aqueous solution to enlarge a diameter of the progenitor communication pore and form the communication for the large pore diameter part;

a second anode oxidization process (A) of anodizing the anode oxidization aluminum material (1A) subjected to pore-diameter enlarging treatment to form a large pore diameter part narrow portion smaller in diameter than the communication pore for the large pore diameter part on an end of the communication pore for the large pore diameter part in the anode oxidization aluminum material subjected to the pore-diameter enlarging treatment and obtain an anode oxidization aluminum material (2);

a third anode oxidization process of anodizing the anode oxidization aluminum material (2) to form a communication pore for the intermediate pore part that is connected to the large pore diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);

a fourth anode oxidization process of anodizing the anode oxidization aluminum material (3) to form a communication pore for a small pore diameter part that is connected to the communication pore for the intermediate pore part and is smaller in diameter than the communication pore for the intermediate pore part and obtain an anode oxidization aluminum material (4);

a separation and etching process of separating an anodized section from the anode oxidization aluminum material (4) and next, executing etching treatment to the separated section to obtain an anodized section; and

a calcination process of firing the anodized section at a temperature of 800 to 1200° C. to obtain a particle capture filtration film, wherein

in the fourth anode oxidization process, the communication pores having an average pore diameter of 4 to 20 nm are formed in a range of 400 nm or more in a thickness direction, and

from the first anode oxidization process to the fourth anode oxidization process, a total thickness of sections on which the communication pores are formed by the anode oxidization is equal to or less than 50 μm.

A manufacturing method of a porous film according to a second embodiment of the present invention includes:

a first anode oxidization process (B) of anodizing an aluminum material to form a communication pore for a large pore diameter part on the aluminum material and obtain an anode oxidization aluminum material (1B);

a second anode oxidization process (B) of anodizing the anode oxidization aluminum material (1B) to form a large pore diameter part narrow portion smaller in diameter than the communication pore for the large pore diameter part on an end of the communication pore for the large pore diameter part in the anode oxidization aluminum material (1B) and obtain an anode oxidization aluminum material (2);

a third anode oxidization process of anodizing the anode oxidization aluminum material (2) to form a communication pore for an intermediate pore part that is connected to the large pore diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);

a fourth anode oxidization process of anodizing the anode oxidization aluminum material (3) to form a communication pore for a small pore diameter part that is connected to the communication pore for the intermediate pore part and is smaller in diameter than the communication pore for the intermediate pore part and obtain an anode oxidization aluminum material (4);

a separation and etching process of separating an anodized section from the anode oxidization aluminum material (4) and next, executing etching treatment to the separated section to obtain an anodized section; and

a calcination process of firing the anodized section at a temperature of 800 to 1200° C. to obtain a particle capture filtration film, wherein

in the fourth anode oxidization process, the communication pores having an average pore diameter of 4 to 20 nm are formed in a range of 400 nm or more in a thickness direction, and

from the first anode oxidization process to the fourth anode oxidization process, a total thickness of sections which the communication pores are formed by the anode oxidization is equal to or less than 50 μm.

The aluminum material, the anode oxidization, the progenitor communication pore of the communication pore for the large pore diameter part, the anode oxidization aluminum material (1A), the first anode oxidization process (A), the communication pore for the large pore diameter part, the pore diameter enlarging process, the anode oxidization aluminum material (1A) subjected to the pore diameter enlarging process, the large pore diameter part narrow portion, the anode oxidization aluminum material (2), the second anode oxidization process (A), the communication pore for the intermediate pore part, the anode oxidization aluminum material (3), the third anode oxidization process, the communication pore for the small pore diameter part, the anode oxidization aluminum material (4), the fourth anode oxidization process, the separation and etching process and the calcination process according to a manufacturing method of the porous film in the first embodiment of the present invention are similar to the aluminum material, the anode oxidization, the progenitor communication pore of the communication pore for the large pore diameter part, the anode oxidization aluminum material (1A), the first anode oxidization process (A), the communication pore for the large pore diameter part, the pore diameter enlarging process, the anode oxidization aluminum material (1A) subjected to the pore diameter enlarging process, the large pore diameter part narrow portion, the anode oxidization aluminum material (2), the second anode oxidization process (A), the communication pore for the intermediate pore part, the anode oxidization aluminum material (3), the third anode oxidization process, the communication pore for the small pore diameter part, the anode oxidization aluminum material (4), the fourth anode oxidization process, the separation and etching process and the calcination process according to the manufacturing method of the particle capture filtration film in the first embodiment of the present invention.

The aluminum material, the anode oxidization, the communication pore for the large pore diameter part, the anode oxidization aluminum material (1B), the first anode oxidization process (B), the large pore diameter part narrow portion, the anode oxidization aluminum material (2), the second anode oxidization process (B), the communication pore for the intermediate pore part, the anode oxidization aluminum material (3), the third anode oxidization process, the communication pore for the small pore diameter part, the anode oxidization aluminum material (4), the fourth anode oxidization process, the separation and etching process and the calcination process according to the manufacturing method of the porous film in the second embodiment of the present invention are similar to the aluminum material, the anode oxidization, the communication pore for the large pore diameter part, the anode oxidization aluminum material (1B), the first anode oxidization process (B), the large pore diameter part narrow portion, the anode oxidization aluminum material (2), the second anode oxidization process (B), the communication pore for the intermediate pore part, the anode oxidization aluminum material (3), the third anode oxidization process, the communication pore for the small pore diameter part, the anode oxidization aluminum material (4), the fourth anode oxidization process, the separation and etching process and the calcination process according to the manufacturing method of the particle capture filtration film in the second embodiment of the present invention.

The manufacturing method of the porous film of the present invention is used for, other than the manufacture of the particle capture filtration film, the manufacture of a porous film used in an enzyme carrier for fixing enzyme by an enzyme electrode or the like, a carbon material, a casting mold of semiconductor wiring, an additive filter for adding a solvent or a solvent medium by an ultralow amount, and is used for executing surface treatment for causing separation of paint to be difficult to be made and forming a porous film on a surface of a base sheet.

### EXAMPLES

Hereinafter, the present invention will be explained with reference to examples. However, the present invention is not limited to the following examples.

### Example 1

Manufacture of Particle capture filtration film

<Preparation of Aluminum Material for Anode Oxidization>

Five aluminum materials of purity 98.5 weight % were prepared. Next, the aluminum materials were irradiated with super sound waves for 30 minutes in acetone, and the electrolytic polishing was made on a condition of 20V and 15 minutes in the 20 mass % perchloric acid ethanol solution, and the aluminum material for anode oxidization was prepared.

<First Anode Oxidization Process>

The aluminum material for anode oxidization obtained in the above was subjected to the anode oxidization under a constant voltage of 100V at a bath temperature of 5° C. using an oxalic acid aqueous solution of 1.8 mass % as an electrolytic solution.

<Second Anode Oxidization Process>

The aluminum material for anode oxidization obtained in the above was subjected to the anode oxidization under a constant voltage of 75V at a bath temperature of 5° C. using an oxalic acid aqueous solution of 1.8 mass % as an electrolytic solution.

<Third Anode Oxidization Process>

Next, an oxalic acid aqueous solution of 1.8 mass % was used as an electrolytic solution, the voltage was gradually reduced at a bath temperature of 5° C. and the anode oxidization was executed for five minutes.

<Fourth Anode Oxidization Process>

Next, in a sulfuric acid aqueous solution of 20 mass %, the voltage was gradually reduced at a bath temperature of 5° C. and the anode oxidization was finally executed at a voltage of 9.5V for 10 minutes.

<Separation and Etching Process>

Next, the anodized section was separated by the electrolytic polishing. Next, the obtained anodized section was washed with ultrapure water, and after that, the anodized section was immersed in the sulfuric acid aqueous solution of 20 weight %, and a surface thereof was etched to form a through film. Next, the through film was washed by ultrapure water.

<Calcination Process>

Next, the calcination was executed at 1000° C. under an atmosphere to obtain a particle capture filtration film.

Analysis of Structure of Particle Capture Filtration Film

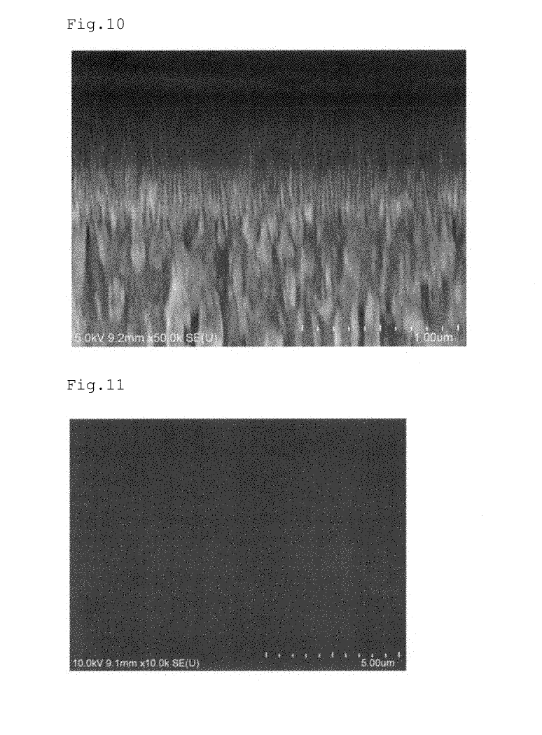

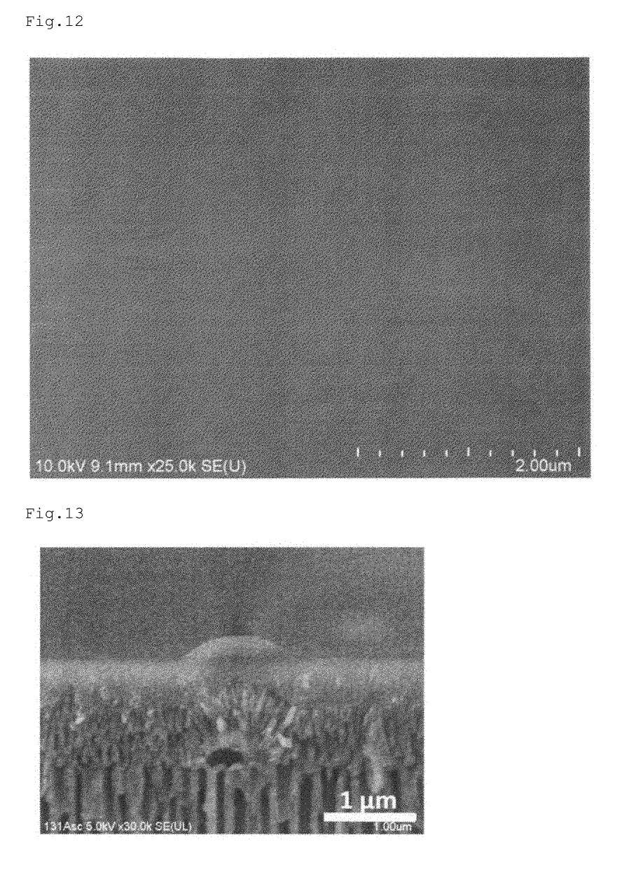

A cross-sectional surface of the obtained particle capture filtration film and a surface thereof in the small pore diameter part side was observed by a scanning electron microscope and the structure was found by the SEM image to be obtained. The SEM image of the obtained cross-sectional surface is shown in FIG. 10, and the SEM image of the surface is shown in FIG. 11 and FIG. 12.

<Small Pore Diameter Part>

A thickness of the small pore diameter part was 790 nm. An average pore diameter of positions of a surface, 300 nm and 700 nm of the small pore diameter part was 10 nm, 10 nm and 10 nm, respectively. An average pore diameter of the communication pores of the whole small pore diameter part was 10 nm. A relative standard deviation in the pore diameter distribution of the communication pores was 21%. An opening rate of the openings of the communication pores of the small pore diameter part was 28%. An existing ratio of the communication pores of the small pore diameter part was 42%.

<Intermediate Pore Part>

A pore diameter of the communication pores of the intermediate pore part was 9 to 43 nm. The pore diameter of the communication pores of the intermediate pore part is a pore diameter of the intermediate pore part in the intermediate position vicinity in the thickness direction. A pore diameter of the communication pores of the intermediate pore part will be the same hereinafter.

<Large Pore Diameter Part Narrow Portion>

An average pore diameter of the large pore diameter part narrow portion of the communication pores of the large pore diameter part was 60 nm.

<Large Pore Diameter Part>

An average pore diameter of the communication pores of the large pore diameter part (section other than the large pore diameter part narrow portion) was 66 nm. When 21 communication pores of the large pore diameter part were optionally extracted for observation, it was confirmed that 19 communication pores each had the narrow section.

<Total Film Thickness of Filtration Film>

A total film thickness of the filtration film was 38 μm.

### Example 2

A first anode oxidization process was executed as similar to Example 1. Next, the anode oxidization aluminum material obtained by executing the first anode oxidization process was immersed in the oxalic acid aqueous solution of 1.8 weight % for four hours to execute pore diameter enlarging treatment. Next, the obtained anode oxidization aluminum material subjected to the pore diameter enlarging treatment was used to execute a second anode oxidization process as similar to Example 1. Next, a third anode oxidization process and processes after that were executed as similar to Example 1 to obtain a particle capture filtration film.

Analysis of Structure of Particle Capture Filtration Film

A cross-sectional surface of the obtained particle capture filtration film and a surface thereof in the small pore diameter part side was observed by a scanning electron microscope and the structure was found by the SEM image to be obtained.

<Small Pore Diameter Part>

A thickness of the small pore diameter part was 730 nm. An average pore diameter of positions of a surface, 200 nm and 400 nm of the small pore diameter part was 10 nm, 10 nm and 10 nm. An average pore diameter of the communication pores of the whole small pore diameter part was 10 nm. A relative standard deviation in the pore diameter distribution of the communication pores was 26%. An opening rate of the openings of the communication pores of the small pore diameter part was 17%. An existing ratio of the communication pores of the small pore diameter part was 42%.

<Intermediate Pore Part>

A pore diameter of the communication pores of the intermediate pore part was 13 to 48 nm. The pore diameter of the communication pores of the intermediate pore part is a pore diameter of the intermediate pore part in the intermediate position vicinity in the thickness direction. A pore diameter of the communication pores of the intermediate pore part will be the same hereinafter.

<Large Pore Diameter Part Narrow Portion>

An average pore diameter of the large pore diameter part narrow portion of the communication pores of the large pore diameter part was 72 nm.

<Large Pore Diameter Part>

An average pore diameter of the communication pores of the large pore diameter part (section other than the large pore diameter part narrow portion) was 99 nm. When 17 communication pores of the large pore diameter part were optionally extracted for observation, it was confirmed that 17 communication pores each had the narrow section.

<Total Film Thickness of Filtration Film>

A total film thickness of the filtration film was 36 μm.

### Comparative Example 1

A first anode oxidization process to a third anode oxidization process were executed as similar to Example 1. Next, the anode oxidization aluminum material obtained by executing the third anode oxidization process was immersed in the oxalic acid aqueous solution of 1.8 weight % for four hours to execute pore diameter enlarging treatment. Next, the obtained anode oxidization aluminum material subjected to the pore diameter enlarging treatment was used to execute a fourth anode oxidization process as similar to Example 1. Next, a separation and etching process and processes after that were executed as similar to Example 1 to obtain a particle capture filtration film.

Analysis of Structure of Particle Capture Filtration Film

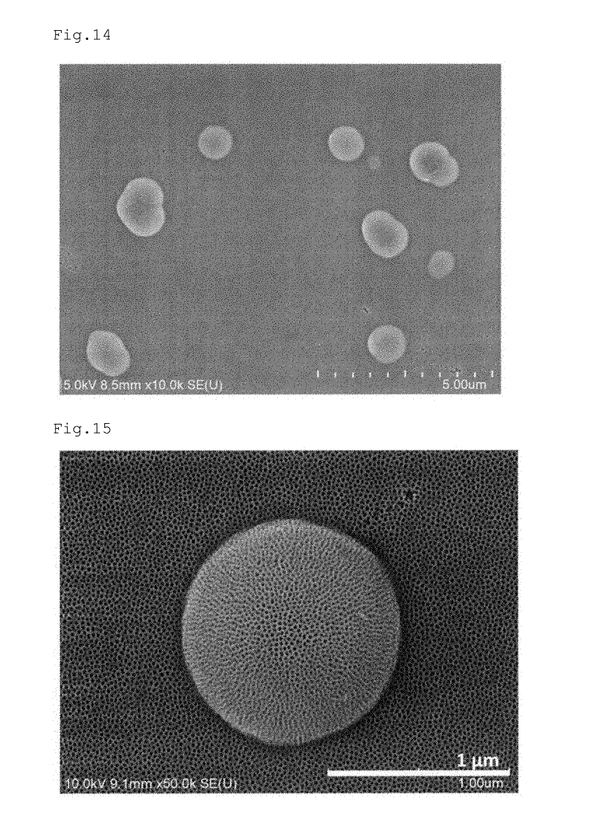

A surface of the obtained particle capture filtration film in the small pore diameter part side was observed by a scanning electron microscope. The SEM image of the obtained cross-sectional surface is shown in FIG. 13, and the SEM image of the surface is shown in FIG. 14 and FIG. 15. As a result, it was found out that a convex portion was produced on the surface of the particle capture filtration film.

### Comparative Example 2

A first anode oxidization process and a second anode oxidization process were executed as similar to Example 1. Using the obtained anode oxidization aluminum material the voltage was gradually lowered from 75V to 25V at a bath temperature of 5° C. using an oxalic acid aqueous solution of 1.8 mass % as an electrolytic solution, and further, the anode oxidization was executed in a constant voltage of 25V at a bath temperature of 5° C. for three minutes. Next, the anode oxidization aluminum material obtained by executing the second anode oxidization process was immersed in an oxalic acid aqueous solution of 1.8 mass % for four hours to execute the pore diameter enlarging treatment. Next, using the obtained anode oxidization aluminum material subjected to pore diameter enlarging treatment the anode oxidization was executed in a constant voltage of 25V at a bath temperature of 5° C. for three minutes using an oxalic acid aqueous solution of 1.8 mass % as an electrolytic solution. Next, a fourth anode oxidization process was executed as similar to Example 1. Next, a separation and etching process and processes after that were executed as similar to Example 1 to obtain a particle capture filtration film.

Analysis of Structure of Particle Capture Filtration Film

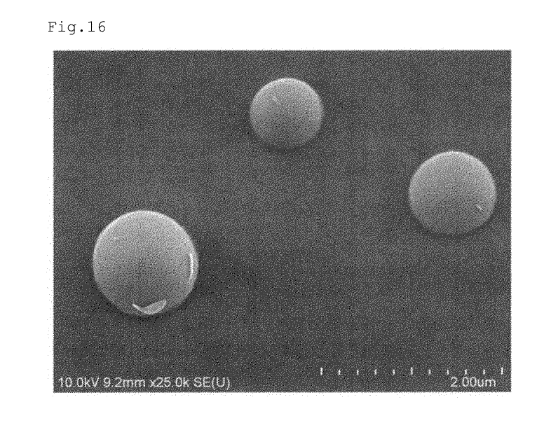

A surface of the obtained particle capture filtration film in the small pore diameter part side was observed by a scanning electron microscope. The SEM image of the obtained surface is shown in FIG. 16. As a result, it was found out that a convex portion was produced on the surface of the particle capture filtration film.

### REFERENCE SIGNS LIST

1 particle capture filtration film
2 small pore diameter part
3 intermediate pore part
4 large pore diameter part
5 one surface of filtration film
6 other surface of filtration film
7 opening of communication pore of small ore diameter part
8 communication pore of small pore diameter part
9 communication pore of intermediate pore part
10 communication pore of large pore diameter part
11 opening of communication pore of large pore diameter part
12 wall, skeleton part
13 large pore diameter part narrow portion
21 water to be treated
22 treatment water
23 aluminum material
24 paired pole material
25 electrolytic solution
26 DC power source
29 anode oxidization aluminum material (1A)
30 anode oxidization aluminum material subjected to pore diameter enlarging treatment (1A)
31 anode oxidization aluminum material (2)
32 anode oxidization aluminum material (3)
33 anode oxidization aluminum material (3)
34 anodized section
35 aluminum material section
81 communication pore for small pore diameter part
91 communication pore for intermediate pore part
102 progenitor communication pore of communication pore of large pore diameter part
103 communication pore for large pore diameter part
104 large pore diameter part narrow portion
201 section corresponding to small pore diameter part
301 section corresponding to intermediate pore part
401 section corresponding to large pore diameter part

1. A particle capture filtration film with communication pores formed by anode oxidization of an aluminum material, comprising:
a small pore diameter part having communication pores formed to open to one surface of the filtration film;
an intermediate pore part having communication pores to which the communication pores of the small pore diameter part are connected and that have a larger diameter than a diameter of the communication pores in the small pore diameter part; and
a large pore diameter part having communication pores to which the communication pores of the intermediate pore part are connected and which have a larger diameter than a diameter of the communication pores in the intermediate pore part and are formed to open to the other surface of the filtration film, wherein
the small pore diameter part is provided with the communication pores formed from the one surface of the filtration film to a position of at least 400 nm, the communication pores having an average pore diameter of 4 to 20 nm,
a total film thickness of the filtration film is equal to or less than 50 μm, and
the communication pores of the large pore diameter part have a large pore diameter part narrow portion in the intermediate pore part side.

2. The particle capture filtration film according to claim 1, wherein
a pore diameter of an opening side of the large pore diameter part is 30 to 300 nm.

3. The particle capture filtration film according to claim 2, wherein
a pore diameter of a large pore diameter part narrow portion of the communication pores of the large pore diameter part is 20 to 200 nm.

4. The particle capture filtration film according to claim 1, wherein
a plurality of the communication pores of the small pore diameter part are connected to the communication pores of the intermediate pore part, and a plurality of the communication pores of the intermediate pore part are connected to the communication pores of the large pore diameter part.

5. The particle capture filtration film according to claim 1, wherein
an opening rate of the communication pores of the small pore diameter part on one surface of the filtration film is 10 to 50%.

6. The particle capture filtration film according to claim 1, wherein
a total film thickness of the whole particle capture filtration film is 15 to 50 μm.

7. A manufacturing method of a particle capture filtration film, comprising:
a first anode oxidization process (A) of anodizing an aluminum material to form a progenitor communication pore of a communication pore for a large pore diameter part on the aluminum material and obtain an anode oxidization aluminum material (1A);
pore diameter enlarging treatment of immersing the anode oxidization aluminum material (1A) in any aqueous solution of an oxalic acid aqueous solution, a chromic acid aqueous solution, a phosphoric acid aqueous solution, a sulfuric acid aqueous solution, a mixed acid aqueous solution of them or an alkaline aqueous solution to enlarge a diameter of the progenitor communication pore and form the communication pore for the large pore diameter part;
a second anode oxidization process (A) of anodizing the anode oxidization aluminum material (1A) subjected to pore diameter enlarging treatment to form a large pore diameter part narrow portion smaller in diameter than the communication pore for the large pore diameter part on an end of the communication pore for the large pore diameter part in the anode oxidization aluminum material (1A) subjected to the pore diameter enlarging treatment and obtain an anode oxidization aluminum material (2);
a third anode oxidization process of anodizing the anode oxidization aluminum material (2) to form a communication pore for an intermediate pore part that is connected to the large pore diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);
a fourth anode oxidization process of anodizing the anode oxidization aluminum material (3) to form a communication pore for a small pore diameter part which is connected to the communication pore for the intermediate pore part and is smaller in diameter than the communication pore for the intermediate pore part and obtain an anode oxidization aluminum material (4);
a separation and etching process of separating an anodized section from the anode oxidization aluminum material (4) and next, executing etching treatment to the separated section to obtain an anodized section; and
a calcination process of firing the anodized section at a temperature of 800 to 1200° C. to obtain a particle capture filtration film, wherein
in the fourth anode oxidization process, the communication pores having an average pore diameter of 4 to 20 nm are formed in a range of 400 nm or more in a thickness direction, and
from the first anode oxidization process to the fourth anode oxidization process, a total thickness of sections on which the communication pores are formed by the anode oxidization is equal to or less than 50 μm.

8. A manufacturing method of a particle capture filtration film, comprising:
a first anode oxidization process (B) of anodizing an aluminum material to form a communication pore for a large pore diameter part on the aluminum material and obtain an anode oxidization aluminum material (1B);
a second anode oxidization process (B) of anodizing the anode oxidization aluminum material (1B) to form a large pore diameter part narrow portion smaller in diameter than the communication pore for the large pore diameter part on an end of the communication pore for the large pore diameter part in the anode oxidization aluminum material (1B) and obtain an anode oxidization aluminum material (2);
a third anode oxidization process of anodizing the anode oxidization aluminum material (2) to form a communication pore for an intermediate pore part that is connected to the large pore diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);
a fourth anode oxidization process of anodizing the anode oxidization aluminum material (3) to form a communication pore for a small pore diameter part that is connected to the communication pore for the intermediate pore part and is smaller in diameter than the communication pore for the intermediate pore part and obtain an anode oxidization aluminum material (4);
a separation and etching process of separating an anodized section from the anode oxidization aluminum material (4) and next, executing etching treatment to the separated section to obtain an anodized section; and
a calcination process of firing the anodized section at a temperature of 800 to 1200° C. to obtain a particle capture filtration film, wherein
in the fourth anode oxidization process, the communication pores having an average pore diameter of 4 to 20 nm are formed in a range of 400 nm or more in a thickness direction, and
from the first anode oxidization process to the fourth anode oxidization process, a total thickness of sections on which the communication pores are formed by the anode oxidization is equal to or less than 50 μm.

9. A porous film with communication pores formed by anode oxidization of an aluminum material, comprising:
a small pore diameter part having communication pores formed to open to one surface of the porous film;
an intermediate pore part having communication pores to which the communication pores of the small pore diameter part are connected and which is larger in diameter than the communication pores in the small pore diameter part; and
a large pore diameter part having communication pores to which the communication pores of the intermediate pore part are connected and which are larger in diameter than the communication pores in the intermediate pore part and are formed to open to the other surface of the porous film, wherein
the small pore diameter part is provided with the communication pores formed from the one surface of the porous film to a position of at least 400 nm, the communication pores having an average pore diameter of 4 to 20 nm,
a total film thickness of the porous film is equal to or less than 50 μm, and
the communication pores of the large pore diameter part have a large pore diameter part narrow portion in the intermediate pore part side.

10. A manufacturing method of a porous film, comprising:
a first anode oxidization process (A) of anodizing an aluminum material to form a progenitor communication pore of a communication pore for a large pore diameter part on the aluminum material and obtain an anode oxidization aluminum material (1A);
pore diameter enlarging treatment of immersing the anode oxidization aluminum material (1A) in any aqueous solution of an oxalic acid aqueous solution, a chromic acid aqueous solution, a phosphoric acid aqueous solution, a sulfuric acid aqueous solution, a mixed acid aqueous solution of them or an alkaline aqueous solution to enlarge a diameter of the progenitor communication pore and form communication pores for a large pore diameter part;
a second anode oxidization process (A) of anodizing the anode oxidization aluminum material (1A) subjected to pore diameter enlarging treatment to form a large pore diameter part narrow portion smaller in diameter than the communication pore for the large pore diameter part on an end of the communication pore for the large pore diameter part in the anode oxidization aluminum material (1A) subjected to the pore diameter enlarging treatment and obtain an anode oxidization aluminum material (2);
a third anode oxidization process of anodizing the anode oxidization aluminum material (2) to form a communication pore for an intermediate pore part that is connected to the large pore diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);
a fourth anode oxidization process of anodizing the anode oxidization aluminum material (3) to form a communication pore for a small pore diameter part that is connected to the communication pore for the intermediate pore part and is smaller in diameter than the communication pore for the intermediate pore part and obtain an anode oxidization aluminum material (4);
a separation and etching process of separating an anodized section from the anode oxidization aluminum material (4) and next, executing etching treatment to the separated section to obtain an anodized section; and
a calcination process of firing the anodized section at a temperature of 800 to 1200° C. to obtain a particle capture filtration film, wherein
in the fourth anode oxidization process, the communication pores having an average pore diameter of 4 to 20 nm are formed in a range of 400 nm or more in a thickness direction, and
from the first anode oxidization process to the fourth anode oxidization process, a total thickness of sections on which the communication pores are formed by the anode oxidization is equal to or less than 50 μm.

11. A manufacturing method of a porous film, comprising:
a first anode oxidization process (B) of anodizing an aluminum material to form a communication pore for a large pore diameter part on the aluminum material and obtain an anode oxidization aluminum material (1B);
a second anode oxidization process (B) of anodizing the anode oxidization aluminum material (1B) to form a large pore diameter part narrow portion smaller in diameter than the communication pore for the large pore diameter part on an end of the communication pore for the large pore diameter part in the anode oxidization aluminum material (1B) and obtain an anode oxidization aluminum material (2);
a third anode oxidization process of anodizing the anode oxidization aluminum material (2) to form a communication pore for an intermediate pore part that is connected to the large pore diameter part narrow portion of the communication pore for the large pore diameter part and is smaller in diameter than the large pore diameter part narrow portion of the communication pore for the large pore diameter part on the anode oxidization aluminum material (2) and obtain an anode oxidization aluminum material (3);
a fourth anode oxidization process of anodizing the anode oxidization aluminum material (3) to form a communication pore for a small pore diameter part that is connected to the communication pore for the intermediate pore part and is smaller in diameter than the communication pore for the intermediate pore part and obtain an anode oxidization aluminum material (4);
a separation and etching process of separating an anodized section from the anode oxidization aluminum material (4) and next, executing etching treatment to the separated section to obtain an anodized section; and
a calcination process of firing the anodized section at a temperature of 800 to 1200° C. to obtain a particle capture filtration film, wherein
in the fourth anode oxidization process, the communication pores having an average pore diameter of 4 to 20 nm are formed in a range of 400 nm or more in a thickness direction, and
from the first anode oxidization process to the fourth anode oxidization process, a total thickness of sections on which the communication pores are formed by the anode oxidization is equal to or less than 50 μm.
